(19) United States
(12) Patent Application Publication
(10) Pub. No.: US 2016/0230915 A1
(43) Pub. Date: Aug. 11, 2016

(54) EXPANSION JOINTS, DAMPERS AND CONTROL SYSTEMS FOR A TUBULAR TRANSPORTATION STRUCTURE STABILITY SYSTEM

(71) Applicant: Hyperloop Technologies, Inc., Los Angeles, CA (US)

(72) Inventors: Kyle COTHERN, Los Angeles, CA (US); Michael GAUNT, Los Angeles, CA (US); Thomas RONACHER, Del Aire, CA (US); Daniel SHAFRIR, Los Angeles, CA (US); Brogan BAMBROGAN, Los Angeles, CA (US); Joshua GIEGEL, Hawthorne, CA (US)

(73) Assignee: Hyperloop Technologies, Inc., Los Angeles, CA (US)

(21) Appl. No.: 15/007,745

(22) Filed: Jan. 27, 2016

Related U.S. Application Data
(60) Provisional application No. 62/239,050, filed on Oct. 8, 2015.
(60) Provisional application No. 62/113,511, filed on Feb. 8, 2015.

(51) Int. Cl. F16L 51/00

(52) U.S. Cl. CPC F16L 51/00

(57) ABSTRACT

A tubular structure stability system includes at least one tube having tube sections and at least one pillar supporting the tube. A tube movement structure is also provided and configured to enable relative movement of the tube sections and/or movement of the tube relative to the at least one pillar.

### CROSS REFERENCE TO RELATED APPLICATIONS

The present application claims the benefit of U.S. Provisional Application No. 62/113,511 filed on Feb. 8, 2015, and U.S. Provisional Application No. 62/239,050 filed on Oct. 8, 2015, the disclosures of which are expressly incorporated by reference herein in their entireties.

### FIELD OF THE DISCLOSURE

The present disclosure relates to expansion joints, dampers and control systems for a tubular transportation structure stability system.

### BACKGROUND OF THE DISCLOSURE

Traditional transportation modes via water, land, rail and air revolutionized the movement and growth of our current culture. Adverse environmental, societal, and economic impacts of these traditional transportation models, however, initiated a movement to find alternative transportation modes that take advantage of the significant improvements in transportation technology, and efficiently move people and materials between locations. High-speed transportation systems utilizing rails or other structural guidance components have been contemplated as a solution to existing transportation challenges while improving safety, decreasing the environmental impact of traditional transportation modes and reducing the overall time commuting between major metropolitan communities.

A high speed, high efficiency transportation system utilizes a low-pressure environment in order to reduce drag on a vehicle at high operating speeds, thus providing the dual benefit of allowing greater speed potential and lowering the energy costs associated with overcoming drag forces. In embodiments, these systems may use a near-vacuum (e.g., low-pressure) environment within a tubular structure.

The tubular structure will be subjected to various environmental, weather, and/or seismic conditions, such as, high winds, thermal variations, and earthquakes that may impart forces on the tubular structure and/or supports for the tubular structure. For example, external disturbances to a transportation system, such as thermal energy and/or earthquakes, can introduce large impulsive forces into infrastructure systems of the transportation system and can have devastating effects on the transportation system. Accordingly, there exists a need for improved methods and structures for reducing an impact of environmental, weather, and/or seismic conditions and/or events on the high-speed transportation system, with the tubular structures able to withstand such forces so as to provide a stable environment for the high-speed transportation system.

### SUMMARY OF THE EMBODIMENTS OF THE DISCLOSURE

Aspects of the present disclosure are directed to a tubular structure stability system, comprising at least one tube having tube sections, at least one pillar supporting the tube, and a tube movement structure configured to enable relative movement of the tube sections and/or enable movement of the tube relative to the at least one pillar.

In further embodiments, the tube movement structure comprises at least one expansion joint connecting the tube sections.

In additional embodiments, the at least one expansion joint comprises a passive expansion joint.

In some embodiments, the at least one expansion joint comprises an actively-controllable expansion joint configured to be selectively actuatable.

In certain embodiments, the at least one expansion joint comprises a first housing attached to a first tube section, and a second housing attached to a second tube section. The first housing is slidably engageable the second housing.

In yet further embodiments, the at least one expansion joint further comprises a plurality of connectors arranged to connect the first housing and the second housing, and respective actuators structured and configured to adjust an effective length of the plurality of connectors so as to selectively control spacing between the first housing and the second housing.

In further embodiments, the respective actuators comprise linear actuators.

In additional embodiments, the respective actuators comprise rotary actuators.

In some embodiments, the at least one expansion joint comprises a gap bridging system operable to actuate at least one gap bridger into a gap between adjacent tube sections.

In certain embodiments, the gap bridging system is a passive gap bridging system.

In yet further embodiments, the gap bridging system is an actively-controllable gap bridging system.

In further embodiments, the gap bridging system is vertically actuatable.

In additional embodiments, the gap bridging system is horizontally actuatable.

In some embodiments, the tube movement structure comprises a sliding arrangement configured to enable relative movement between a respective tube and a respective pillar, and a damping arrangement configured to damp movement between the respective tube and the respective pillar.

In certain embodiments, the sliding arrangement comprises a plurality of longitudinal rails fixed positionally relative to the respective tube, a plurality of lateral rails fixed positionally relative to the respective pillar, and a plurality of sliders, each slider being configured to be slidable along one of the plurality of longitudinal rails and one of the plurality of lateral rails.

In yet further embodiments, the plurality of longitudinal rails are arranged orthogonally relative to the plurality of lateral rails.

In further embodiments, the damping arrangement comprises a longitudinal damping arrangement structured and arranged to damp a longitudinal movement of the tube relative to the at least one pillar, and a lateral damping arrangement structured and arranged to damp lateral movement of the tube relative to the at least one pillar.

In additional embodiments, the damping arrangement comprises a damper having a first end attached via mechanical connection to the pillar and a second end in mechanical connection to the tube.

In some embodiments, the damper additionally comprises an actuator selectively controllable to alter an effective length of the damper.

In certain embodiments, the damper arrangement comprises at least one actively-controllable damper.

In yet further embodiments, the damping arrangement comprises at least one vertical damper.

In further embodiments, the tubular structure stability system further comprises a mobile command center configured to monitor and/or control the tube movement structure.

In additional embodiments, the tubular structure stability system further comprises a pillar movement structure configured to enable movement of the at least one pillar relative to ground on which the at least one pillar is supported.

In some embodiments, the tubular structure stability system further comprises at least one vortex shedding fin arranged on at least one tube section and/or at least one pillar.

In certain embodiments, the at least one tube is configured as a low-pressure environment.

In yet further embodiments, the at least one expansion joint is structured and configured to maintain a low-pressure environment within the connected tube sections.

In further embodiments, the tubular structure stability system further comprises at least one track along a transportation path within the at least one tube, a plurality of capsules configured for travel through the at least one tube between stations, a propulsion system adapted to propel the at least one capsule through the tube, and a levitation system adapted to levitate the capsule within the tube.

Additional aspects of the present disclosure are direct to a method of actively controlling the tubular structure stability system comprising at least one tube having tube sections, at least one pillar supporting the tube, and a tube movement structure configured to enable relative movement of the tube sections and/or enable movement of the tube relative to the at least one pillar, the method comprising receiving a command for actuation of an expansion joint and/or a damper; and executing the command to move at least one of the expansion joint and the damper.

### BRIEF DESCRIPTION OF THE DRAWINGS

The novel features which are characteristic of the systems, both as to structure and method of operation thereof, together with further aims and advantages thereof, will be understood from the following description, considered in connection with the accompanying drawings, in which embodiments of the system are illustrated by way of example. It is to be expressly understood, however, that the drawings are for the purpose of illustration and description only, and they are not intended as a definition of the limits of the system. For a more complete understanding of the disclosure, as well as other aims and further features thereof, reference may be had to the following detailed description of the disclosure in conjunction with the following exemplary and non-limiting drawings wherein:

FIG. 1 is a schematic view of a transportation system in accordance with embodiments of the present disclosure;

FIG. 2 illustrates a view of an exemplary capsule for use in the transportation system in accordance with embodiments of the present disclosure;

FIG. 3 illustrates a schematic perspective view of aspects of a tubular structure stability system in accordance with embodiments of the present disclosure;

FIG. 4 illustrates a schematic perspective partial cut-away view of aspects of a tubular structure stability system in accordance with embodiments of the present disclosure;

FIG. 5 illustrates a schematic sectional view of an exemplary expansion joint in accordance with embodiments of the present disclosure;

FIG. 6 illustrates a schematic partial cut-away view of an exemplary expansion joint in accordance with embodiments of the present disclosure;

FIGS. 7A-7B illustrate schematic sectional views of exemplary expansion joints in accordance with embodiments of the present disclosure;

FIG. 8 illustrates a schematic sectional view of an exemplary expansion joint with an exemplary bridging system in accordance with embodiments of the present disclosure;

FIG. 9 illustrates a schematic sectional view of an exemplary expansion joint with an exemplary bridging system in accordance with embodiments of the present disclosure;

FIG. 10 illustrates a schematic perspective view of an exemplary damping system in accordance with embodiments of the present disclosure;

FIG. 11 illustrates a schematic perspective partial cut-away view of an exemplary damping system in accordance with embodiments of the present disclosure;

FIG. 12 illustrates a schematic view of an exemplary damping system in accordance with embodiments of the present disclosure;

FIG. 13 illustrates a schematic view of an exemplary active damping system in accordance with embodiments of the present disclosure;

FIG. 14 illustrates a schematic view of a mobile command center in accordance with embodiments of the present disclosure;

FIG. 15 illustrates a schematic view of an exemplary relative location of an expansion joint in accordance with embodiments of the present disclosure;

FIG. 16 illustrates a schematic view of an exemplary active tubular structure stability system in accordance with embodiments of the present disclosure;

FIG. 17 illustrates a perspective partial cut-away view of a portion of an exemplary low-pressure environment structure with an exemplary damping system in accordance with embodiments of the present disclosure;

FIG. 18 illustrates a schematic view of an exemplary damping system in accordance with embodiments of the present disclosure;

FIGS. 19A-19B illustrate schematic views of an exemplary stabilization arrangement in accordance with embodiments of the present disclosure;

FIG. 20 illustrates an exemplary process for controlling a tubular structure stability system in accordance with embodiments of the present disclosure; and

FIG. 21 is an exemplary system environment for use in accordance with the embodiments of control systems described herein.

### DETAILED DISCLOSURE

In the following description, the various embodiments of the present disclosure will be described with respect to the enclosed drawings. As required, detailed embodiments of the embodiments of the present disclosure are discussed herein; however, it is to be understood that the disclosed embodiments are merely exemplary of the embodiments of the disclosure that may be embodied in various and alternative forms. The figures are not necessarily to scale and some features may be exaggerated or minimized to show details of particular components. Therefore, specific structural and functional details disclosed herein are not to be interpreted as limiting, but merely as a representative basis for teaching one skilled in the art to variously employ the present disclosure.

The particulars shown herein are by way of example and for purposes of illustrative discussion of the embodiments of the present disclosure only and are presented in the cause of providing what is believed to be the most useful and readily understood description of the principles and conceptual aspects of the present disclosure. In this regard, no attempt is made to show structural details of the present disclosure in more detail than is necessary for the fundamental understanding of the present disclosure, such that the description, taken with the drawings, making apparent to those skilled in the art how the forms of the present disclosure may be embodied in practice.

As used herein, the singular forms “a,” “an,” and “the” include the plural reference unless the context clearly dictates otherwise. For example, reference to “a magnetic material” would also indicate that mixtures of one or more magnetic materials can be present unless specifically excluded.

Except where otherwise indicated, all numbers expressing quantities used in the specification and claims are to be understood as being modified in all instances by the term “about.” Accordingly, unless indicated to the contrary, the numerical parameters set forth in the specification and claims are approximations that may vary depending upon the desired properties sought to be obtained by embodiments of the present disclosure. At the very least, and not to be considered as an attempt to limit the application of the doctrine of equivalents to the scope of the claims, each numerical parameter should be construed in light of the number of significant digits and ordinary rounding conventions (unless otherwise explicitly indicated).

Additionally, the recitation of numerical ranges within this specification is considered to be a disclosure of all numerical values and ranges within that range (unless otherwise explicitly indicated). For example, if a range is from about 1 to about 50, it is deemed to include, for example, 1, 7, 34, 46.1, 23.7, or any other value or range within the range.

The various embodiments disclosed herein can be used separately and in various combinations unless specifically stated to the contrary.

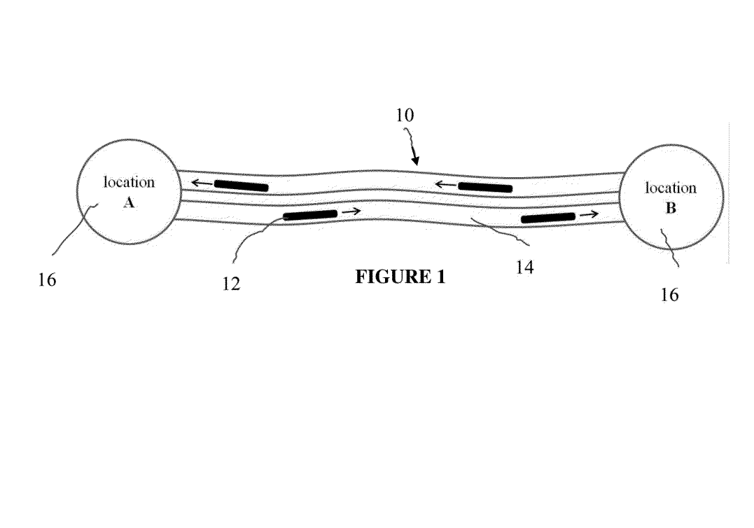

Referring to FIG. 1, a transportation system 10 in accordance with aspects of the present disclosure is illustrated. In embodiments, the transportation system 10 comprises one or more capsules or transport pods 12 traveling through at least one enclosed structure (e.g., a tube) 14 between two or more stations 16. In one exemplary embodiment of the present disclosure, the capsules 12 of the transportation system 10 move through a low-pressure environment within the at least one enclosed structure 14. In accordance with certain aspects of the disclosure, a low-pressure environment includes (but is not limited to) any pressure that is below 1 atmosphere (or approximately 1 bar) at sea level.

Some elements of a high-speed transportation system are discussed in commonly-assigned U.S. application Ser. No. 15/007,783, entitled “Transportation System,” filed in the USPTO on even date herewith, the entire content of which is expressly incorporated by reference herein in its entirety.

In embodiments of the present disclosure, a transportation system comprises one or more partially evacuated enclosed structures 14 that connect the stations 16 in a closed loop system. In embodiments, enclosed structures 14 may be sized for optimal air flow around the capsule 12 to improve performance and energy consumption efficiency at the expected or design travel speed. In accordance with aspects of the disclosure, the low-pressure environment in the enclosed structures 14 minimizes the drag force on the capsule 12, while maintaining the relative ease of pumping out the air from the tubes.

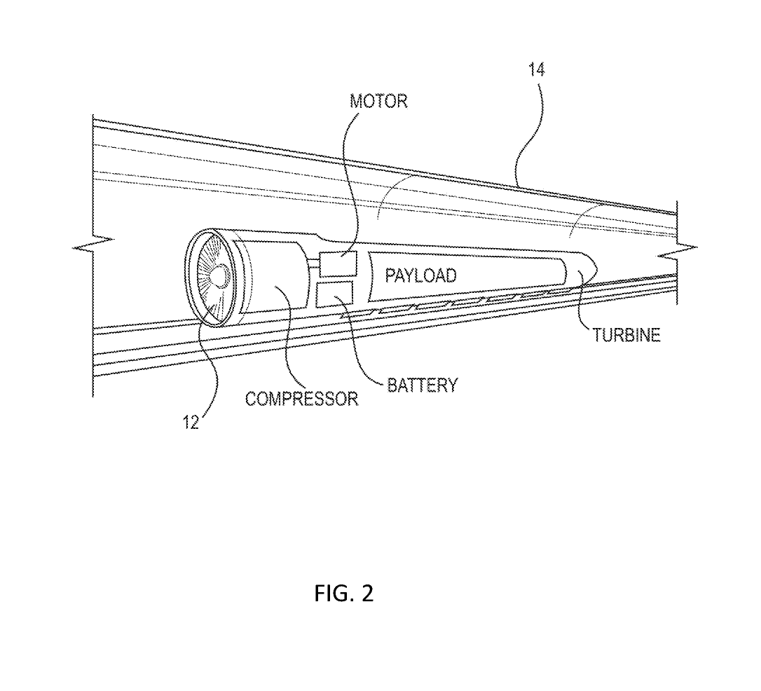

Referring now to FIG. 2, an exemplary and non-limiting depiction of a capsule or transport pod 12 of the transportation system is illustrated. In embodiments, the capsule 12 may be streamlined to reduce an air drag coefficient as the capsule 12 travels through the low-pressure environment of the at least one enclosed structure 14 (e.g., tube) of the transportation system. In accordance with aspects of the disclosure, in certain embodiments, a compressor arranged at the front end of the capsule is operable to ingest at least a portion of the incoming air and pass it through the capsule (instead of displacing the air around the vehicle). For example, as schematically shown in the exemplary embodiment of FIG. 2, the capsule 12 may include a compressor at its leading face. In embodiments, the compressor is operable to ingest oncoming air and utilize the compressed air for the levitation process (when, for example, the capsules are supported via air bearings that operate using a compressed air reservoir and aerodynamic lift). Additionally, as schematically shown in the exemplary embodiment of FIG. 2, in embodiments, the compressed air may be used to spin a turbine, for example, located at the rear end of the capsule, to provide power to the capsule 12. As schematically shown in the exemplary embodiment of FIG. 2, the capsule 12 may also include a motor structured and arranged to drive the compressor, and a battery for storing energy, e.g., derived from the turbine. The capsule 12 also includes a payload area, which may be configured for humans, for cargo, and/or for both humans and cargo.

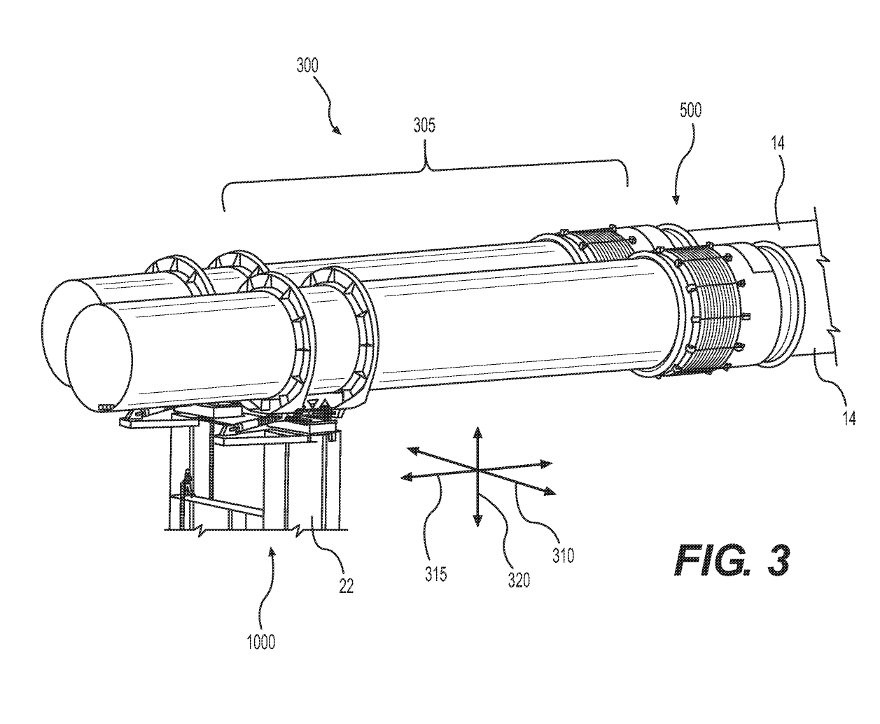

FIG. 3 illustrates a schematic perspective view 300 of exemplary aspects of a tubular structure stability system in accordance with embodiments of the present disclosure. As shown in the non-limiting embodiment of FIG. 3, a pair of cylindrical tubes 14 are generally positioned in a side-by-side configuration. In accordance with aspects of the disclosure, the side-by-side configuration of tubes 14 may decrease the overall physical footprint of the transportation system and provides efficient use and management of utilities and system components. In certain embodiments, tubes 14 are supported above ground (not shown) by a series of supports (e.g., pillars or pylons 22, with only one shown in FIG. 3) spaced apart along a path of travel. In an exemplary and non-limiting embodiment, the pillars 22 may be placed approximately every 100 feet (30 m) along the transportation path.

In accordance with aspects of the disclosure, embodiments include one or more systems for isolating a tubular system from the ground, for example, through the use of linear slides and dampers, as well as thermal expansion joints, to allow the relatively rigid tube to translate (or move) relative to the support pylons and/or expand or contract as necessary to compensate for, e.g., the daily thermal cycle and/or internal system heat production. As discussed herein, embodiments may utilize, for example, local linear slides and spring-dampers that enable centering and long timescale expansion and contraction of the tube. Embodiments may also utilize axial expansion joints (e.g., periodic axial expansion joints) to compensate for any limitation of travel of the tube on the pylon that may be imposed by the structure and operational range of the linear slides and dampers. As discussed herein, embodiments enable an expansion of tube to be translated onto the axial (or longitudinal) and transverse (or lateral) planes. For example, with some embodiments, up to one meter of axial and transverse movement may be displaced locally to the pylons. Additionally, in one exemplary embodiment, a thermal expansion joint may be configured to undergo up to 1.5 meters of expansion for every kilometer of the tube length, which can accommodate up to a 100 degree Celsius temperature change in the tube structure.

As shown in FIG. 3, in some embodiments, the tubular structure stability system 300 may include at least one expansion joint 500 arranged on a tube 14, which is structured and arranged to enable a relative movement between sections of the tube 14 in longitudinal directions 315 to adjust for longitudinal forces acting on the tubes 14 (e.g., expansion and/or contraction of tubes due to thermal conditions).

Additionally, as shown in FIG. 3, in some embodiments, the tubular structure stability system 300 may include at least one damper system 1000 having one or more dampers and slide arrangements between respective pillars 22 and tubes 14 to adjust for imposed lateral forces in direction 310 and/or longitudinal forces in direction 315 (e.g., due to forces caused by the capsule movement, thermal considerations, and/or seismic events). In certain embodiments, the tubes 14 may be fixed to the dampening system 1000, and the dampening system 1000 is supported by pillars 22. In some embodiments, the pillars 22 and the dampening system 1000 are structured and arranged to constrain the tubes 14 in a vertical direction (i.e., direction 320) while allowing for relative longitudinal (i.e., direction 315) and lateral movement (i.e., direction 310) of the tube 14 relative to a respective pillar 22.

In additional embodiments, the damper system 1000 may also include a vertical damper (not shown) to adjust for vertical forces in vertical direction 320 (e.g., due to forces caused by the capsule movement, thermal considerations, and/or seismic events). Some embodiments may also allow for some movement in the vertical direction between the pillars 22 and the tubes 18, 20, and/or between the pillar and the ground. In addition, in accordance with aspects of the disclosure, the position of the pillar-to-tube connection may be adjustable vertically and/or laterally, for example, to ensure proper alignment of the tube, and/or to provide for a smoother ride.

As shown in FIG. 3, in some embodiments, the expansion joint 500 may be arranged along a transportation tube 14 at a distance 305 from a pillar 22. In certain embodiments, as discussed herein, distance 305 may be located a distance from a respective pillar 22 along the tube 14 that has a minimum moment point. In other contemplated embodiments, distance 305 may be approximately zero (e.g., an expansion joint 500 is arranged approximately adjacent to a damper system 1000). In other embodiments, the expansion joint 500 may be arranged anywhere along the tube 14. In further embodiments of the present disclosure, expansion (or slip) joints may be provided at each station (or, e.g., approximate to each station) to adjust for tube length variance due to, for example, thermal expansion.

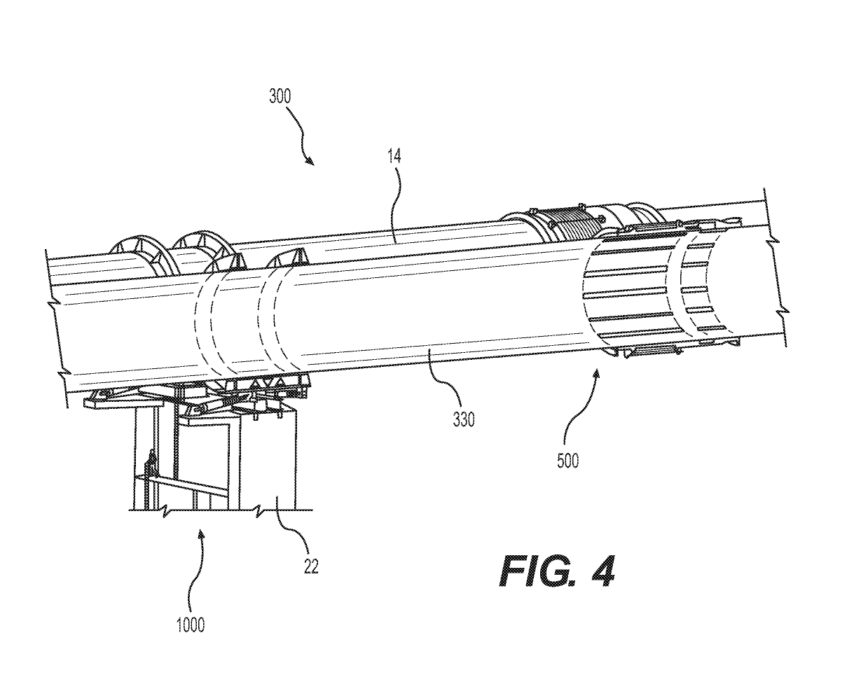

FIG. 4 illustrates a schematic perspective partial cut-away view of aspects of tubular structure stability system 300 in accordance with embodiments of the present disclosure. As shown in FIG. 4, the tubular structure stability system 300 may include at least one expansion joint 500 arranged on each of the respective tubes 14, which is structured and arranged to permit a relative movement between sections of the tube 14 in longitudinal directions to adjust for longitudinal forces acting on the tubes 14. Additionally, the tubular structure stability system 300 may include at least one damper system 1000 having one or more dampers and sliding arrangements between respective pillars 22 and tubes 14 to adjust for lateral forces in lateral direction and/or longitudinal forces in longitudinal direction (e.g., due to forces caused by the capsule movement, thermal considerations, and/or seismic events). As shown in the exemplary partial cut-away view of FIG. 4, an interior 330 of a tube 14 is depicted.

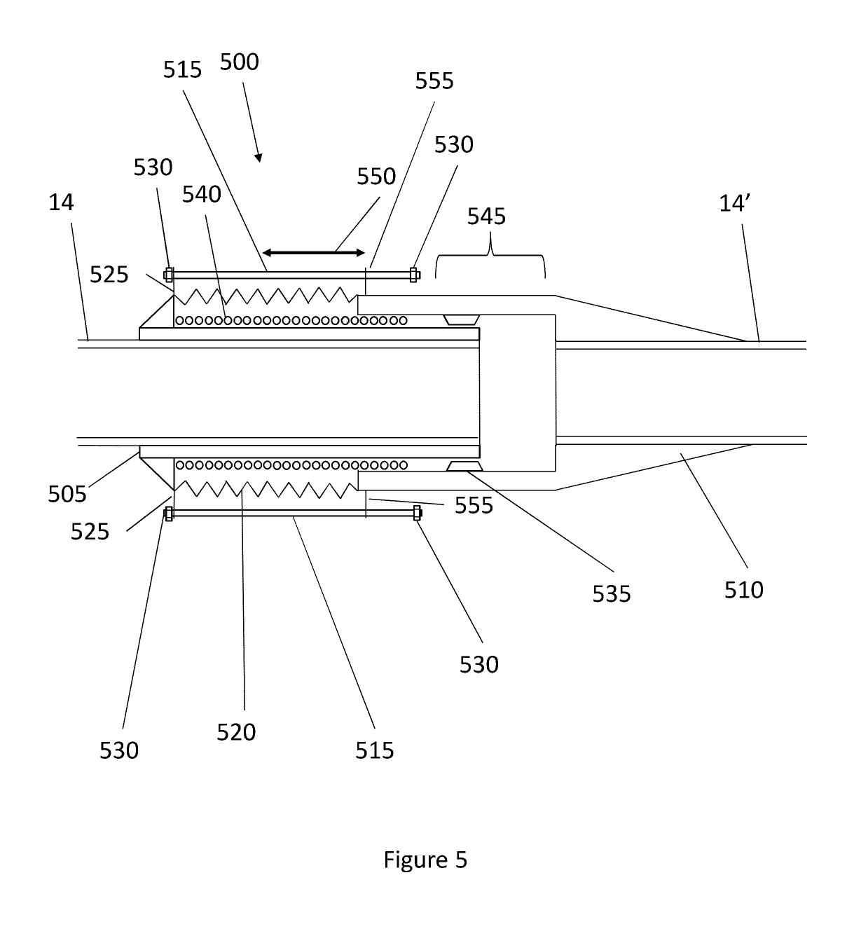

FIG. 5 illustrates a schematic sectional view of an exemplary expansion joint 500 in accordance with embodiments of the present disclosure. As shown in FIG. 5, the expansion joint 500 is arranged between two adjacent tube sections 14 and 14′. With the exemplary embodiment of FIG. 5, the expansion joint 500 includes a first housing 505 arranged on tube section 14 and a second housing 510 arranged on tube section 14′. In embodiments, the first housing 505 and second housing may be, for example, welded, bolted, and/or fastened to the respective tube sections. The second housing 510 is structured and arranged such that an interior portion thereof is operable to slidably engage with the first housing 505 to permit a relative longitudinal movement of tube section 14 and/or tube section 14′ in direction 550 through a schematically-depicted distance 545 (which should not be construed as limiting the present disclosure).

As shown in FIG. 5, the second housing 510 may include at least one projection 535 structured and configured to provide a sliding guide/support surface and/or to maintain a seal (e.g., an air-tight seal) between the first housing 505 and the second housing 510. In embodiments, the at least one projection may comprise a metal, a rubber, a polymer, or other suitable materials. The first housing 505 also includes one or more seals 540 (e.g., O-rings or some other compressible material with suitable sealing properties) structured and arranged to maintain a seal (e.g., an air-tight seal) between the first housing 505 and the second housing 510. As the tube sections 14, 14′ move relative to one another, the one or more seals 540 are structured and arranged to compress and/or expand so as to maintain the seal between the tube sections. As also depicted in FIG. 5, in some embodiments, the expansion joint 500 additionally includes a flexible and expandable cover 520 connected between the first housing 505 and the second housing 510. As the expansion joint 500 undergoes expansion and/or contraction, the cover 520 is operable to maintain an enclosure around the interior of the expansion joint 500. In embodiments, the cover 520 is configured to provide additional sealing properties so as to assist in maintaining a seal (e.g., an air-tight seal) between the first housing 505 and the second housing 510. In embodiments, the cover 520 may alternatively (or additionally) be configured to prevent dust or other debris from entering the expansion joint 500 from the outside environment.

As shown in FIG. 5, the expansion joint 500 may also include a plurality of connectors 515 arranged in and between respective first housing brackets 525 and second housing brackets 555. In embodiments, the plurality of connectors 515 may be regularly-spaced (e.g., at regular angular intervals) around the circumference of the expansion joint 500. As the expansion joint 500 contracts, for example, the connector 515 (e.g., one end thereof) is configured to slide in a corresponding bracket (e.g., a first and/or a second housing bracket) to help maintain an alignment of the respective tube section 14, 14′. End bolts 530 may be arranged on respective ends of the connectors 515, and may be configured for establishing endpoints of relative movement between the tube sections 14, 14′ in the expansion joint 500.

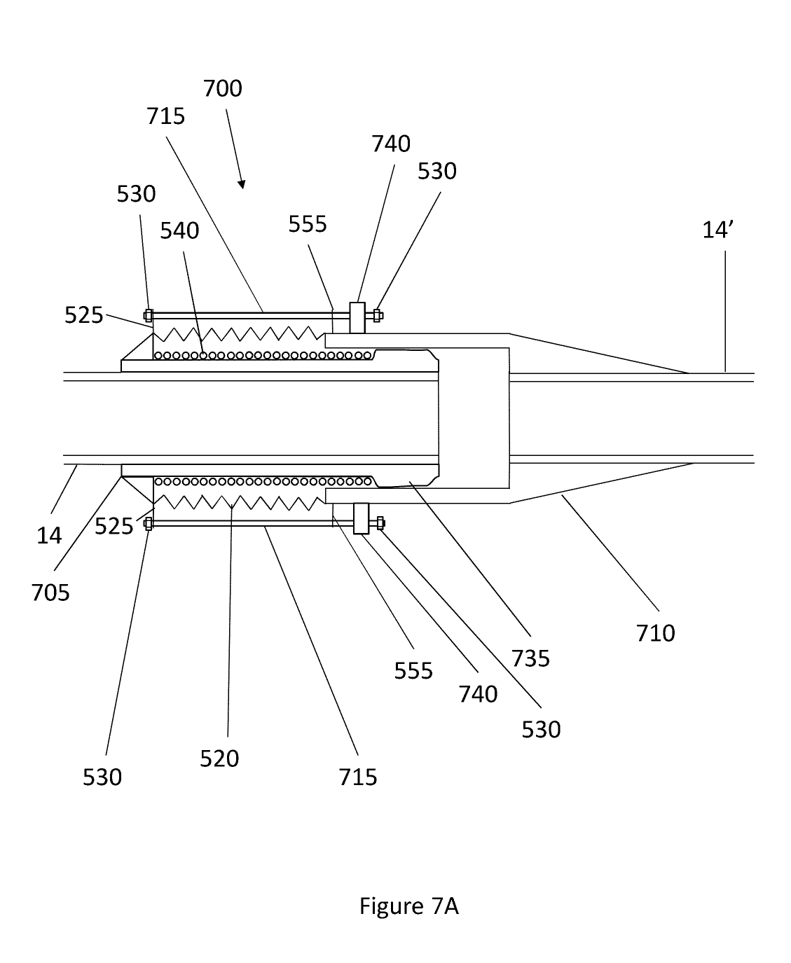

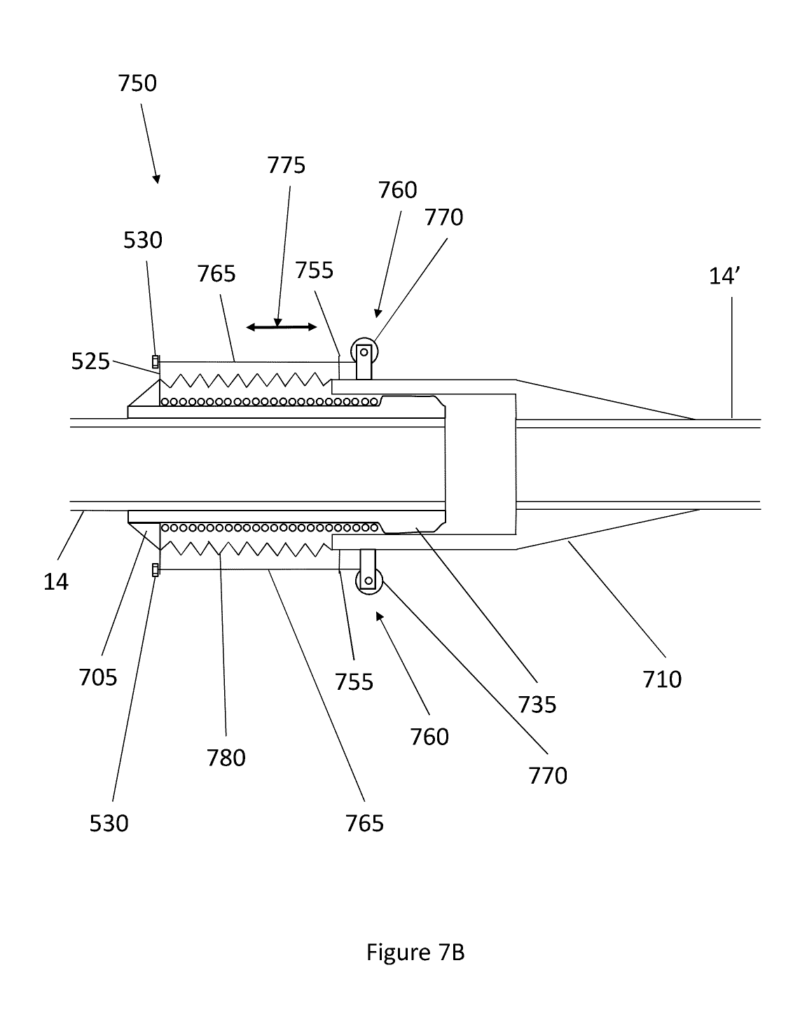

In some embodiments, the expansion joint 500 may be configured as a passive expansion joint that is operable to react to current environmental conditions (e.g., in real-time) to passively adjust (e.g., without receiving a command) a relative spacing of the tube sections. In further contemplated embodiments, for example, as discussed below with reference to FIGS. 7A and B, an expansion joint may be configured as an active expansion joint that is also operable to receive and execute expansion joint control commands to actuate one or more expansion joints. In such embodiments, the expansion joint may additionally include one or more actuators 740 (see, e.g., FIGS. 7A and 7B) structured and configured to actively adjust a relative spacing of the tube sections.

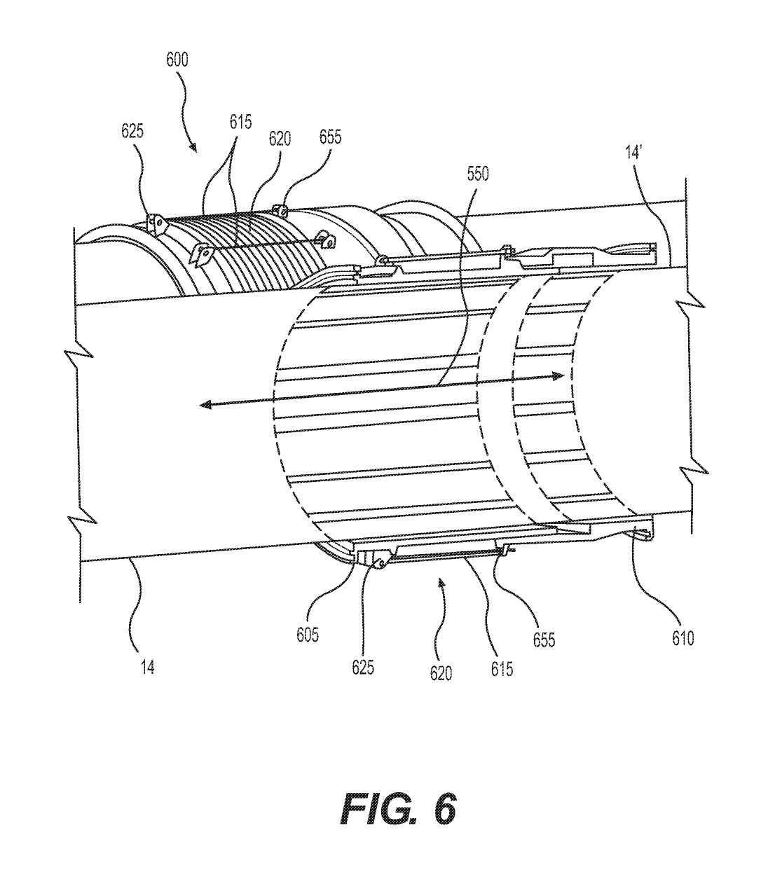

FIG. 6 illustrates a schematic partial cut-away view of an exemplary expansion joint 600 in accordance with embodiments of the present disclosure. As shown in FIG. 6, the expansion joint 600 is arranged between two adjacent tube sections 14 and 14′. With the exemplary embodiment of FIG. 6, the expansion joint 600 includes a first housing 605 arranged on tube section 14 and a second housing 610 arranged on tube section 14′. The second housing 610 is structured and arranged such that an interior thereof is operable to slidably engage with the first housing 605 to permit a relative longitudinal movement of tube section 14 and/or tube section 14′ in direction 550.

As shown in FIG. 6, the expansion joint 600 additionally includes a flexible and expandable cover 620 connected between the first housing 605 and the second housing 610. As the expansion joint 600 undergoes expansion and/or contraction, the cover 620 is operable to maintain an enclosure around the interior of the expansion joint 600. In embodiments, the cover 620 is configured to provide additional sealing properties so as to assist in maintaining a seal (e.g., an air-tight seal) between the first housing 605 and the second housing 610. In embodiments, the cover 620 may alternatively (or additionally) be configured to prevent dust or other debris from entering the expansion joint from the outside environment.

As shown in FIG. 6, the expansion joint 600 may also include a plurality of connectors 615 arranged in and between respective first housing brackets 625 and second housing brackets 655. In embodiments, the plurality of connectors 615 may be regularly-spaced (e.g., at regular angular intervals) around the circumference of the expansion joint 600. As the expansion joint 600 contracts, for example, the connector 615 (e.g., one end thereof) is configured to help maintain an alignment of the respective tube sections 14, 14′.

FIGS. 7A-7B illustrate schematic sectional views of exemplary expansion joints in accordance with embodiments of the present disclosure. As shown in FIG. 7A, expansion joint 700 is arranged between two adjacent tube sections 14 and 14′. With the exemplary embodiment of FIG. 7, the expansion joint 700 includes a first housing 705 arranged on tube section 14 and a second housing 710 arranged on tube section 14′. The second housing 710 is structured and arranged such that an interior thereof is operable to slidably engage with the first housing 705 to permit a relative longitudinal movement of tube section 14 and/or tube section 14′.

As shown in FIG. 7A, the first housing 705 may include at least one projection 735 structured and configured to provide a sliding guide/support surface and/or to maintain a seal (e.g., an air-tight seal) between the first housing 705 and the second housing 710. That is, in contrast to the embodiment of FIG. 5 (wherein the at least one projection 535 is arranged (or formed) on the second housing), with the exemplary embodiment of FIG. 7, the at least one projection 735 is arranged on (or part of) the first housing 705.

The first housing 705 also includes at least one seals 540 (e.g., O-rings or some other compressible material with suitable sealing properties) structured and arranged to maintain a seal (e.g., an air-tight seal) between the first housing 705 and the second housing 710. As also depicted in FIG. 7A, in some embodiments, the expansion joint 700 additionally includes a flexible and expandable cover 520 connected between the first housing 705 and the second housing 710. As the expansion joint 700 undergoes expansion and/or contraction, the cover 520 is operable to maintain an enclosure around the interior of the expansion joint 700.

As shown in FIG. 7A, the expansion joint 700 may also include a plurality of connectors 715 arranged in and between respective first housing brackets 525 and second housing brackets 555. In embodiments, the plurality of connectors 715 may be regularly-spaced (e.g., at regular angular intervals) around the circumference of the expansion joint 700. As the expansion joint 700 contracts, for example, the connector 715 (e.g., one end thereof) is configured to slide in a corresponding bracket (e.g., a first and/or a second housing bracket) to help maintain an alignment of the respective tubes 14, 14′. End bolts 530 may be arranged on respective ends of the connectors 515, and may be configured to establish endpoints of relative movement between the tube sections 14, 14′ in the expansion joint 700.

In some embodiments, the expansion joint 700 may be configured as an active expansion joint that (in addition to passive operation, e.g., as described above) is also operable to receive, transmit, and execute expansion joint control commands to actuate one or more expansion joints 700. In such embodiments, the expansion joint 700 may additionally include one or more actuators 740 structured and arranged to actively adjust a relative spacing of the tube sections. For example, as shown in FIG. 7A, the actuators 740 are configured and arranged to be engagable with respective connectors 715 and are operable to positively engage with and move the connectors 715 there-through so as to actuate a relative movement of the tubes 14. In embodiments, the plurality of actuators 740 at a respective expansion joint 700 are operable to communicate with each other (e.g., upon receiving an actuation command) so as to move together when performing an actuation, so as to maintain an alignment of the tube sections 14, 14′. Sensors (e.g., optical sensors) may be provided to detect an actual (e.g., real-time) relative position of the tube sections 14, 14′ to assist in controlling the expansion joint 700. With one exemplary embodiment, the actuator 740 may include, for example, a pinion (or other suitable engagement device) structured and arranged to engage with a corresponding “rack” structure (or other suitable corresponding engagement device) on a connector 715 to as to actuate the movement of expansion joint 700. The actuator 740 may also include a motor (e.g., a servo motor, rotary motor, and/or linear motor) configured for moving a respective connector 715 through the actuator 740.

FIG. 7B illustrates a schematic sectional view of another exemplary active expansion joint 750 in accordance with embodiments of the present disclosure. In contrast to the active expansion joint 700 of FIG. 7A, as shown in FIG. 7B, with expansion joint 750, one or more cable connectors 765 are connected from respective first housing brackets 525, through second housing brackets 755 and to an actuator 760. For example, in response to a received command to contract, actuator 760, which may be configured as a rotary actuator (e.g., having a suitable rotary motor), is operable to wind (or retract) the cable connector 765 onto a receiving spool 770 so as to pull the tube sections together, and thus actively alter the relative spacing of the tube sections. In embodiments, the plurality of connector cables 765 may be regularly-spaced (e.g., at regular angular intervals) around the circumference of the expansion joint 750. End bolts 530 may be arranged on ends of the cable connectors 715 to fasten the cable connectors 715 to the first housing brackets 525.

As also depicted in FIG. 7B, in some embodiments, the expansion joint 750 additionally includes a flexible and expandable cover 780 connected between the first housing 705 and the second housing 710 operable to maintain an enclosure around the interior of the expansion joint 700. In embodiments, the cover 780 may alternatively (or additionally) be configured to provide a longitudinally-directed expansion force 775 (e.g., similar to a coiled spring) so as to maintain the cable connectors 715 in a tensioned state. In such embodiments, the cover 780 may additionally include spring elements (not shown) structured and arranged within (or on) the cover 780 to provide a longitudinally-directed expansion force 775. Upon receiving a command to expand, the actuator 760 is operable to unwind the cable connector 765 from the receiving spool 770, and the tube sections are moved apart by the longitudinally-directed expansion force 775 exerted by the cover 780.

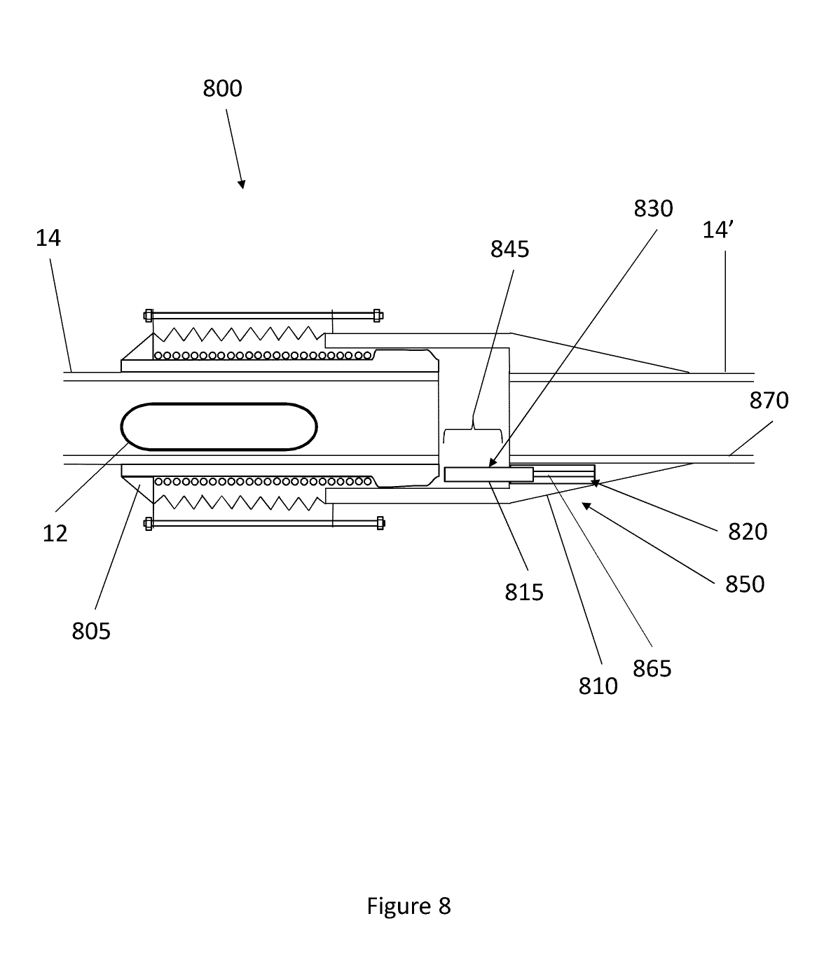

FIG. 8 illustrates a schematic sectional view of an exemplary expansion joint 800 with an exemplary bridging system 850 in accordance with embodiments of the present disclosure. As the tube sections 14, 14′ move together and apart from one another, a gap 845 in the track surface (of varying size depending on the relative spacing of the tube sections 14, 14′) may be presented to a passing capsule 12. (It should be understood that the depicted size of the gap has been exaggerated so as to more clearly explain aspects of the disclosure.) This gap 845 in the track surface may cause a disturbance to a passing capsule, for example, which may be configured to levitate (e.g., magnetically and/or via a fluid cushion) above the track surface. For example, this gap 845 may lack one or more elements of a track (e.g., elements of levitation, propulsion, and/or auxiliary tracks as otherwise may be provided in the tubes 14). In accordance with aspects of the disclosure, by reducing this area of the gap 845 (e.g., in a width and/or length direction), disturbances to the capsule 12 passing over the gap 845 may be lessened, minimized, or eliminated.

Thus, in accordance with additional aspects of the disclosure, in embodiments, the expansion joint 800 may include a bridging system 850 configured to move a gap bridging section 815 into a region of the gap 845. In embodiments, the bridging system 850 includes an actuator 865 (e.g., a linear motor, a rotary motor, a servo motor, a mechanical linkage, a spring) structured and arranged to move the gap bridging section 815 from a bridge housing 820 into the gap 845. In certain embodiments, the gap bridging section 815 may include at least one surface 830 having one or more elements of the levitation, propulsion, and/or auxiliary tracks, as otherwise may be provided in one or more portions of the tubes 14. For example, the surface 830 of the gap bridging section 815 may include an air bearing track and/or a wheeled track surface (e.g., a rail). While with the schematically-depicted example of FIG. 8, the surface 830 of the gap bridging section 815 is not depicted as coplanar with the inner surface 870 of the tube sections 14, 14′, it should be understood that, at least in some embodiments, the bridging system 850 is operable to position the surface 830 of the gap bridging section 815 approximately coplanar with the inner (e.g., capsule-supporting) surface 870 of the tube sections 14, 14′. By implementing these aspects of the disclosure, disturbances to the capsule 12 as it traverses the gap 845 may be minimized.

In embodiments, the bridging system 850 may be passive or may be actively-controlled. For example, with a passive arrangement, the actuator 865 may comprise at least one spring (not shown) operable to urge the gap bridging section 815 out of the bridge housing 820 so that the gap bridging section 815 is maintained in approximate contact with the first housing 705. As the first housing 705 moves rightward (as depicted in FIG. 8) towards the second housing 810, the end of the first housing 705 is structured and arranged to push the gap bridging section 815 back into the bridge housing 820.

Alternatively, with an active bridging system, the actuator 865 may include a motor (e.g., a linear motor, a rotary motor, or a servo motor), structured and arranged to move the gap bridging section 815 from a bridge housing 820 into the gap 845, and the bridging system 850 may include an active controller (not shown) comprising at least one processor, and which is operable to receive control commands and actuate the bridging system 850 (for example, in conjunction with an actively-controlled expansion joint).

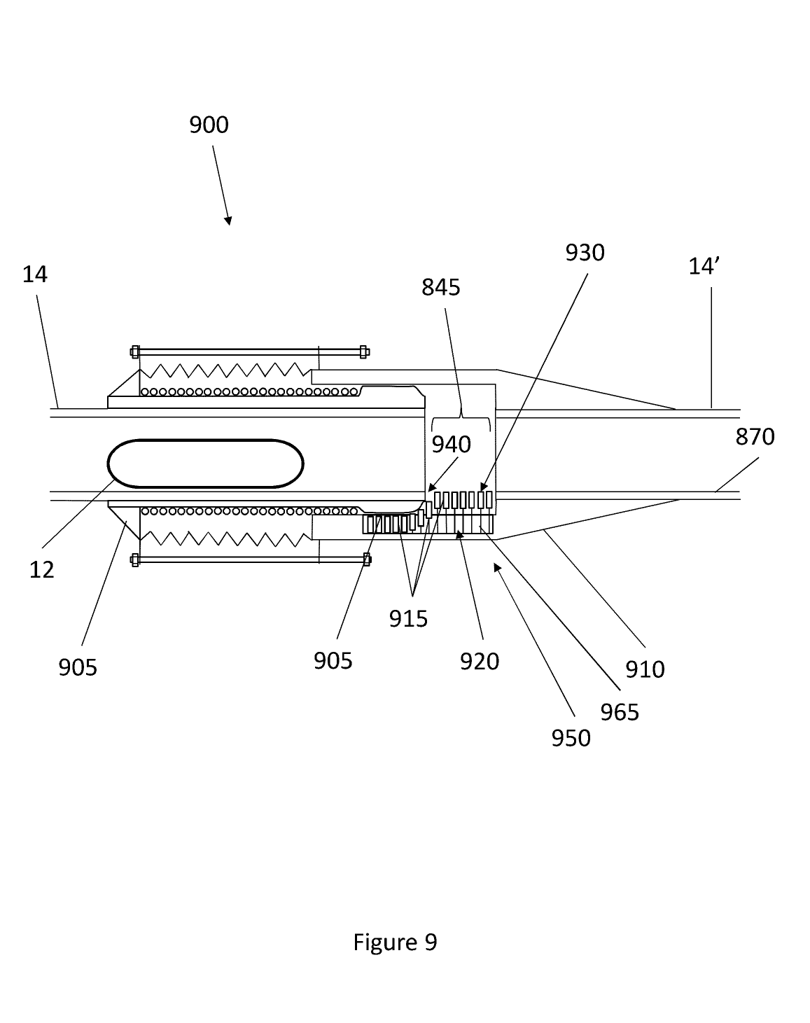

FIG. 9 illustrates a schematic sectional view of an exemplary expansion joint 900 with another exemplary bridging system 950 in accordance with embodiments of the present disclosure. As shown in FIG. 9, the bridging system 950 is configured to move at least one gap bridging section 915 into a region of the gap 845. In embodiments, the bridging system 950 includes at least one actuator 965 (e.g., a linear motor, a rotary motor, a servo motor, a mechanical linkage, a spring) structured and arranged to move the at least one gap bridging section 915 from a bridge housing 920 into the gap 845. In certain embodiments, the gap bridging section 915 may include at least one surface 930 having one or more elements of the levitation, propulsion, and/or auxiliary tracks, as otherwise may be provided in one or more portions of the tubes 14. For example, the surface 930 of the gap bridging section 915 may include an air bearing track and/or a wheeled track surface (e.g., a rail). By implementing these aspects of the disclosure, disturbances to the capsule 12 as it traverses the gap 845 may be minimized.

In embodiments, the bridging system 950 may be passive or may be actively-controlled. For example, with a passive arrangement, the actuator 965 may comprise at least one spring (not shown) operable to urge the gap bridging section 915 out of the bridge housing 920 so that, when unconstrained by a surface 940 of the first housing 905, the surface 930 of at least one gap bridging section 915 is maintained approximately co-planar with the inner surface 870 of the tube sections 14 contact with the first housing 705. As the first housing 905 moves rightward towards the second housing 910, the surface 940 of the first housing 905 is structured and arranged to push the gap bridging sections 915 back into the bridge housing 920.

Alternatively, with an active bridging system, the actuators 965 may include motors (e.g., one or more linear motors, rotary motors, or servo motors), structured and arranged to move the gap bridging sections 915 from a bridge housing 920 into the gap 845, and the bridging system 950 may include an active controller (not shown) comprising at least one processor, and which is operable to receive control commands and actuate the bridging system 950 (for example, in conjunction with an actively-controlled expansion joint).

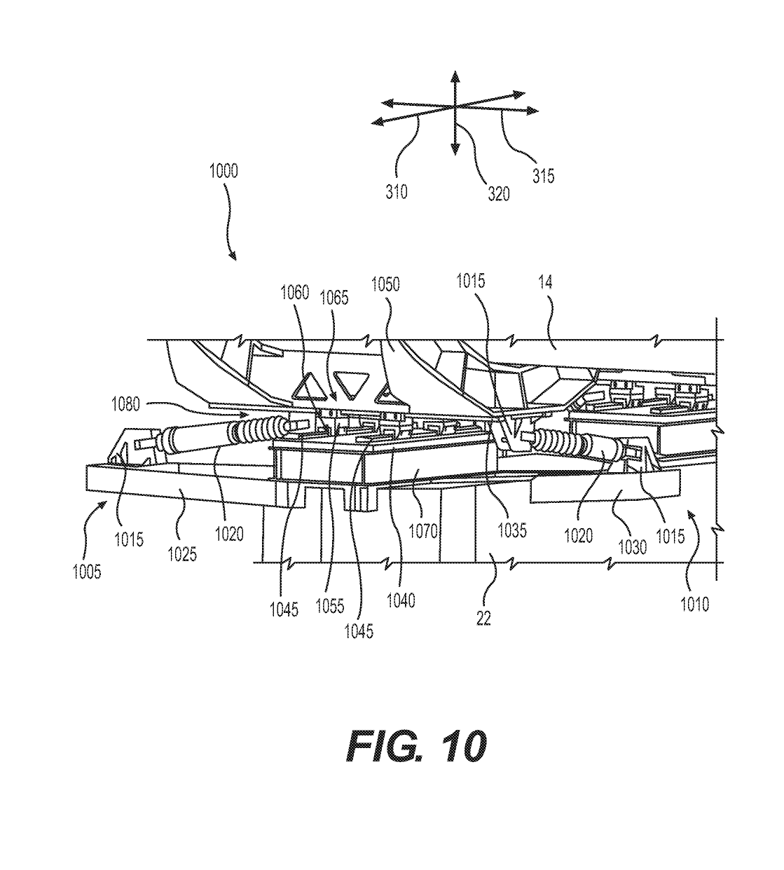

FIG. 10 illustrates a schematic perspective view of an exemplary damping system 1000 in accordance with embodiments of the present disclosure. As shown in FIG. 10, in some embodiments, the damping system 1000 includes one or more damper arrangements 1005, 1010 and sliding arrangements 1080 between respective pillars 22 and tubes 14 to adjust for (or compensate for) lateral forces in direction 310 and/or longitudinal forces in direction 315 (e.g., due to forces caused by the capsule movement, thermal considerations, and/or seismic events). In certain embodiments, the tubes 14 may be fixed to the damping system 1000 via tube attachments 1050 and longitudinal rails 1035. In some embodiments, the tubes 14 may be attached to the tube attachments 1050, for example, by welding and/or fasteners, and the tube attachments 1050 may be attached to the longitudinal rails 1035, for example, by welding and/or fasteners. The damping system 1000 is supported by at least one pillar 22. In some embodiments, the pillars 22 and the damping system 1000 are structured and arranged to constrain the tubes 14 in a vertical direction (i.e., direction 320) while allowing for relative longitudinal (i.e., direction 315) and lateral movement (i.e., direction 310) of the tube 14 relative to a respective pillar 22.

As shown in FIG. 10, the dampening system 1000 includes a longitudinal damper arrangement 1005 structured and arranged to dampen a relative longitudinal (i.e., direction 315) movement, and a lateral damper arrangement 1010 structured and arranged to dampen a relative lateral (i.e., direction 310) movement. The longitudinal damper arrangement 1005 includes a pylon mount 1025 securely attached to the pylon 22 with a damper attachment 1015 affixed to the pylon mount 1025. A damper 1020 (e.g., comprising a spring, a pneumatic cylinder, a hydraulic cylinder, a resilient material, and/or a compressible material) has one end attached to the damper attachment 1015 and its other end attached to the tube attachment 1050 via another damper attachment (not shown). The lateral damper arrangement 1010 includes a pylon mount 1030 securely attached to the pylon 22 with a damper attachment 1015 affixed to the pylon mount 1030. A damper 1020 has one end attached to the damper attachment 1015 and its other end attached to the tube attachment 1050 via another damper attachment 1015.

As additionally shown in FIG. 10, a support 1070 is attached to the pillar 22 (and/or one of the pylon mounts 1025, 1030). A sliding arrangement 1080 comprising a slider surface 1040 is arranged on the support 1070, and a pair of lateral rails 1045 is arranged on the slider surface 1040 with a longitudinal axis of the lateral rails 1045 arranged along the lateral direction of the tubes (e.g., direction 310). A plurality of sliders 1055 are structured and arranged between the lateral rails 1045 and the longitudinal rails 1035, so that each respective slider 1055 has a corresponding receiving slot 1060 configured to ride on one of the lateral rails 1045 and a corresponding receiving slot 1065 configured to ride on one of the longitudinal rails 1035. As the plurality of sliders 1055 ride (or slide) on the lateral rails 1045, the plurality of sliders 1055 may also be supported (at least partially) by the slide surface 1040. As such, in embodiments, the slide surface 1040 may be configured to have a low coefficient of friction. Likewise, as the plurality of sliders 1055 are structured and arranged to ride the longitudinal rails 1035 such that a portion of the sliders 1055 may contact the tube attachment 1050 (to which the longitudinal rails 1035 are attached), the tube attachment 1050 (or portions thereof) may be configured to have a low coefficient of friction.

In accordance with aspects of the disclosure, as forces act on the tube 14 that impart movement to the tube 14, the tube 14 can move relative to the pillar 22 through the sliding arrangement 1080, comprising the respective sliders 1055 riding on the lateral rails 1045 and the longitudinal rails 1035, and this relative movement is damped by the dampers 1020 of the longitudinal damper arrangement 1005 and/or the lateral damper arrangement 1010. For example, with a longitudinal movement of tube 14, the tube 14, together with the tube support 1050 and the longitudinal rails 1035, are able to slide in direction 315 within an upper receiving slot 1065 of the plurality of sliders 1055, and this longitudinal sliding movement may be damped by the longitudinal damper arrangement 1005. Additionally, with a lateral movement of the tube 14, the tube 14, together with the tube support 1050, the longitudinal rails 1035, and the plurality of sliders 1055, are able to slide on lateral rails 1045 in direction 310 (with the lateral rails 1045 being received in a lower receiving slot 1060 of the plurality of sliders 1055), and this lateral sliding movement may be damped by the lateral damper arrangement 1010.

In further contemplated embodiments, the dampers 1020 may be configured to additionally function as actuators. For example, the damper 1020 (in addition to the damping components) may also include a linear actuator configured to selectively vary a length of the damper 1020.

In accordance with additional aspects of the disclosure, by utilizing the sliders 1055 engaged with the lateral rails 1045 and the longitudinal rails 1035, the relative movement of the tube 14 with respect to the pillar 22 may be constrained (to a certain extent) to move in directions that are damped by the respective damper arrangements 1005 and 1010. For example, any relatively “diagonal” movement of the tube 14 relative to the pillar 22, by virtue of the sliders 1055 being engaged with the lateral rails 1045 and the longitudinal rails 1035, will result in a combination of respective lateral and longitudinal movements.

In additional embodiments, the damper system 1000 may also include a vertical damper to adjust for vertical forces in vertical direction 320 (e.g., due to forces caused by the capsule movement, thermal considerations, and/or seismic events). With such embodiments, for example, the support 1070 may be configured as a vertical damper. For example, the support 1070 may be a compressible material (e.g., rubber or other material with suitable properties) that allows for some relative vertical movement between the pillar 22 (on which the support 1070 is arranged) and the slide surface 1040 (which supports the tube 14).

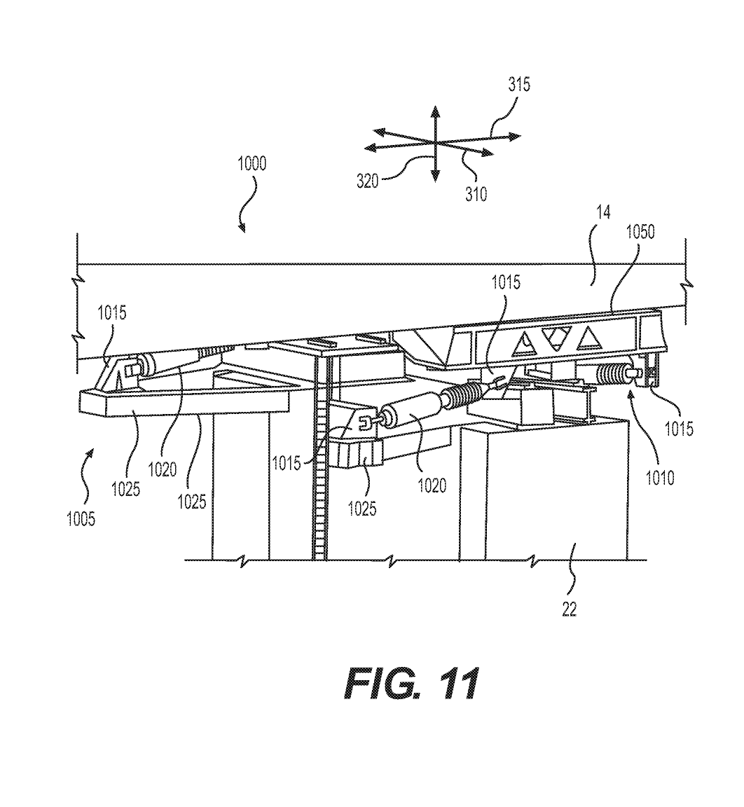

FIG. 11 illustrates a schematic perspective partial cut-away view of an exemplary damping system 1000 in accordance with embodiments of the present disclosure. As shown in FIG. 11, the dampening system 1000 for each tube 14 includes a longitudinal damper arrangement 1005 structured and arranged to dampen a relative longitudinal (i.e., direction 315) movement, and a lateral damper arrangement 1010 structured and arranged to dampen a relative lateral (i.e., direction 310) movement. The longitudinal damper 1005 includes a pylon mount 1025 securely attached to the pylon 22 with a damper attachment 1015 affixed to the pylon mount 1025. A damper 1020 has one end attached to the damper attachment 1015 and its other end attached to the tube attachment 1050 via another damper attachment 1015. The lateral damper 1010 includes a pylon mount (not shown) securely attached (e.g., welded, bolted, fastened) to the pylon 22 with a damper attachment (not shown) affixed to the pylon mount. A damper 1020 has one end attached to the damper attachment on the pylon mount and its other end attached to the tube attachment 1050 via another damper attachment 1015.

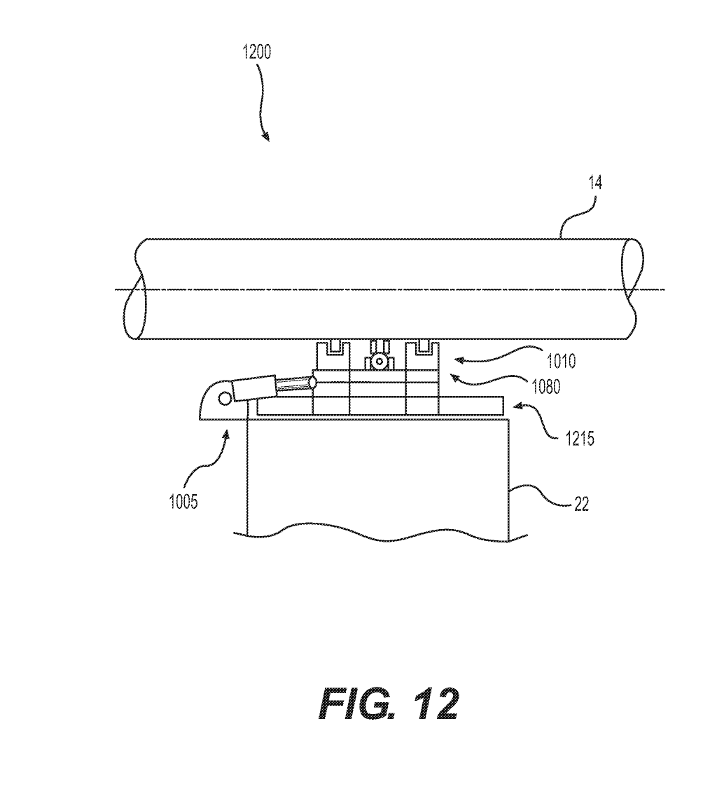

FIG. 12 illustrates a schematic view of an exemplary damping system 1200 in accordance with embodiments of the present disclosure. As shown in FIG. 12, damping system 1200 includes a sliding arrangement 1080, a longitudinal damper arrangement 1005 structured and arranged to dampen a relative longitudinal movement of a tube 14 relative to a pylon 22, and a lateral damper arrangement 1010 structured and arranged to dampen a relative lateral movement the of tube 14 relative to the pylon 22. FIG. 12 also schematically illustrates a THK rail 1215.

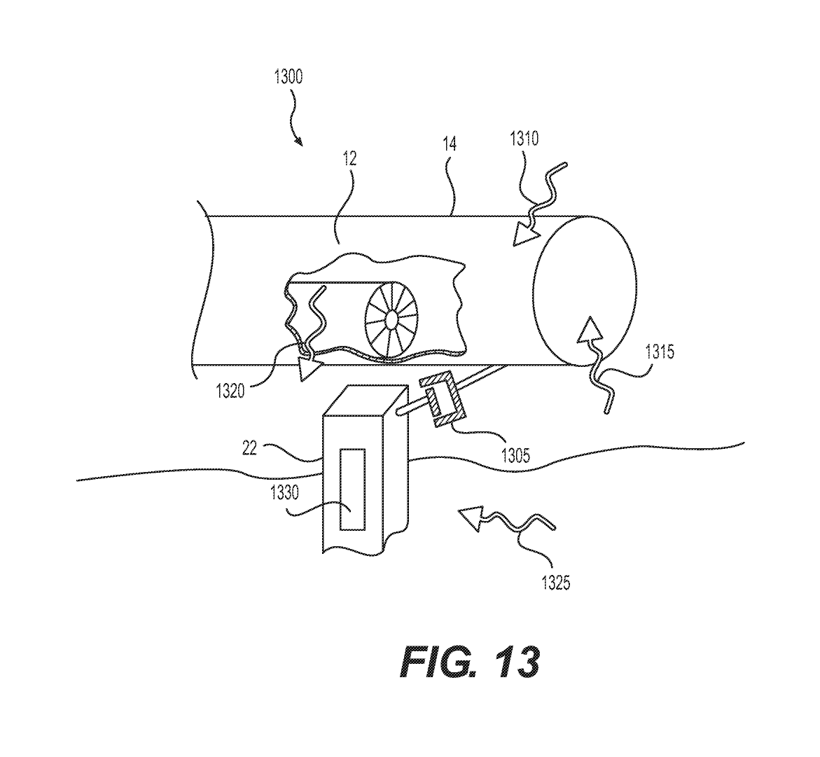

FIG. 13 illustrates a schematic view of an exemplary active damping system 1300 in accordance with embodiments of the present disclosure. In some embodiments of the transportation system, elements of the tube and the track are able to communicate with each other so as to, for example, control one or more operating conditions of the tube or track. As one example, during a seismic event, portions of a tube that detect (e.g., with appropriate sensors) the seismic activity that are closer in proximity to the epicenter of the seismic activity, may communicate with portions of the tube that are further from the epicenter to adjust operating conditions of the tube and/or tube support structures (e.g., expansion joints, or vibration damping elements) to account for the seismic activity (or prepare for an impending seismic event) for example, by increasing a damping amount, or moving elements of the tube and support structure. Aspects of the present disclosure are directed to an active damping/stiffness system operable to facilitate structure active damping/stiffness responses in response to control inputs.

In accordance with aspects of the disclosure, as schematically depicted in FIG. 13, a transportation system may utilize an active damping/stiffness system 1300 operable to, for example, brace the tube route for, e.g., seismic disturbances, or to de-stiffen (e.g., lower a damping amount) to connections between respective tube section to allow for, e.g., thermal expansion. In embodiments, actuators for expansion joints and/or dampers may be altered over the course of a day to alter the tubes intrinsic ability to overcome physical system noise. In some embodiments, the active damping/stiffness system 1300 may be configured to locally alter the natural response of the tube 14 (and/or support pillars 22) to specific disturbances (e.g., an impending seismic event). For example, with an impending seismic event the damping/stiffness system 1300 may be configured to de-stiffen the natural response of the tube 14 (and/or support pillars 22 to allow the tube to move more freely, or conversely, to stiffen the natural response of the tube 14 (and/or support pillars 22 to decrease a movement between the tube. Additionally, in some embodiments, one or more active control systems may be used to add a degree of freedom in response to some detrimental force. In embodiments, disturbances may include disturbances 1325 propagating through the ground (e.g., seismic activity) and disturbances 1310 propagating through the air (e.g., wind shears, thermal changes). Additionally, disturbances may include disturbances 1320 caused by a capsule 12 passing in the tube 14, and disturbances 1315 propagating down the tube 14.

In embodiments, as schematically depicted in FIG. 13, the tube 14 and pylon 22 may be connected together by an active damper 1305 (e.g., a linear bearing or rail system). The active damper 1305 is structured and arranged to allow the tube to “float” on the pylon supports, for example, as discussed herein. In contemplated embodiments, the active damper may comprise rail systems (as discussed above), one or more flat plates, and/or profiled rollers (e.g., exotically profiled rollers). As noted above, in contemplated embodiments, the dampers 1305 may be configured to additionally function as actuators. For example, the damper 1305 (in addition to the damping components) may also include a linear actuator configured to selectively vary a length of the damper 1305.

As also shown in FIG. 13, each actively controlled pylon 22 may include an active controller 1330 (having at least one processor) and configured to actively control aspects of the tube stability system (e.g., the damping system and/or the tube expansion joints). In certain embodiments, the active controller 1330 comprises one or more sensors (e.g., seismic sensors, optical sensors, thermal sensors, and/or gyroscopes) to provide real-time data to the controller 1330. In such a manner, in embodiments, the pylon 22 is a self-sufficient active controller. In further embodiments, the controller 1330 may be further operable to receive control signals, e.g., via satellite, mobile, or other suitable communication system, and provide active control of the damping system and/or the tube expansion joints based on the received control signals. In yet further embodiments, the controller 1330 may be operable to send control signals, e.g., via satellite, mobile, or other suitable communication system, to respective controllers of other pylons (e.g., adjacent pylons).

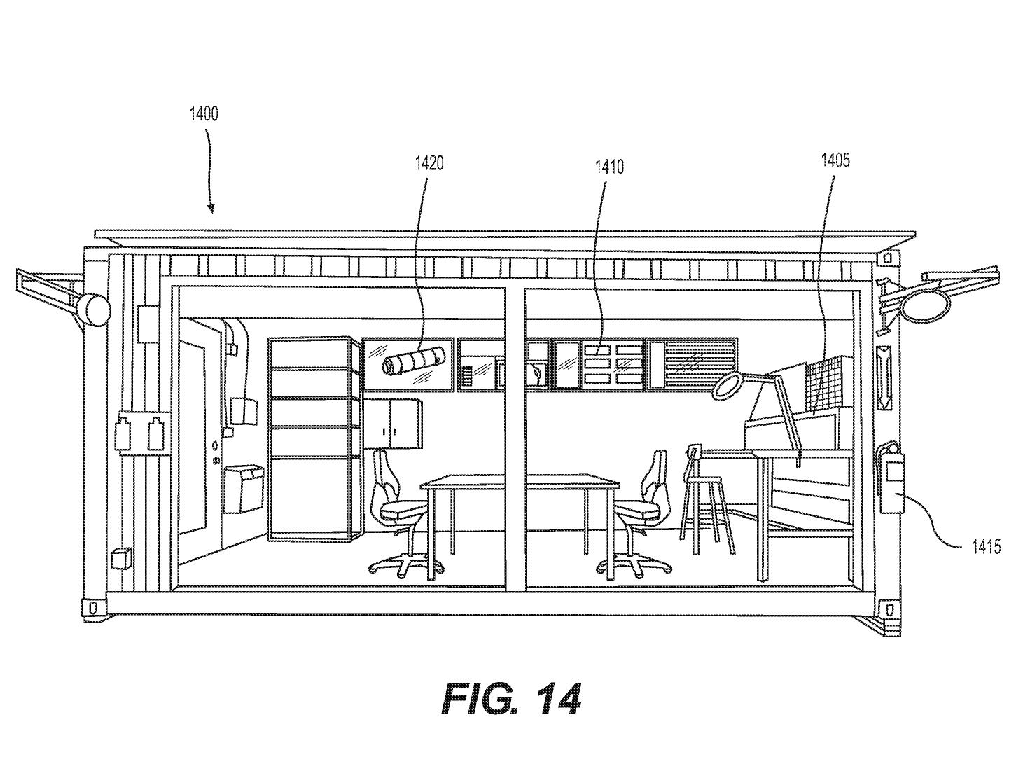

FIG. 14 illustrates a schematic view of a mobile command center 1400 in accordance with embodiments of the present disclosure. In some embodiments, a plurality of mobile data command and control centers 1400 configured for on-site data monitoring and/or fabrication may be utilized along a transportation route (e.g., near regions of high seismic activity) to control (or communicate with) one or more actively-controlled tube stabilization systems. In an exemplary and non-limiting embodiment, a command center 1400 can be built within a cargo container may house equipment to run, maintain, and/or test aspects of the transportation system. For example, the mobile command center 1400 may include at least one communication system 1405 (e.g., cellular, satellite, Wi-Fi) operable to communicate with other mobile command centers, one or more central commands, and/or one or more controllers 1330 for a tube stabilization system (see, e.g., FIG. 13). The command center 1400 may also include a tube monitoring system 1410 operable to receive one or more operating conditions of at least one tube stabilization system and/or one or more environmental conditions (e.g., high wind speeds, seismic activity). The command center 1400 may also include a tube stabilization system controller 1420 operable to determine appropriate tube stabilization controls based on current (e.g., real time) operating conditions. In embodiments, the mobile command center 1400 may also include safety equipment 1415 (e.g., fire extinguishers).

In accordance with aspects of the disclosure, by locating the mobile command centers 1400 in known “hot spots” (e.g., areas of relatively high thermal or seismic activity) along the tube route, active controlling of tube stabilization systems (e.g., dampers and/or expansion joints) can be improved. For example, due to a proximity of the mobile command center 1400 to the actively-controlled pylons and/or tubes in these “hot spots”, the commands to these actively-controlled pylons and/or tubes can be received more quickly, and thus remedial action can be undertaken more quickly.

In embodiments, the mobile command centers 1400 may include a plurality of computer-aided design (CAD) stations and/or a plurality of finite element analysis (FEA) stations, data acquisition hardware such as remote-sensors connected to monitors, light hardware fabrication, and test monitoring stations. Additionally, in embodiments, the mobile command center 1400 may utilize information from the tube and associated hardware to further tube development.

In accordance with aspects of the disclosure, the mobile command centers 1400 may be modular, such that they may easily be reconfigured and/or repurposed for different uses, such as testing or monitoring, for example, by switching the equipment contained therein. In embodiments, the mobile command centers 1400 may be configured to accommodate a plurality of users. In some contemplated embodiments, mobile command centers 1400 may contain distinct functions, such as, for example, monitoring, technician and fabrication laboratory, and an employee lounge area.

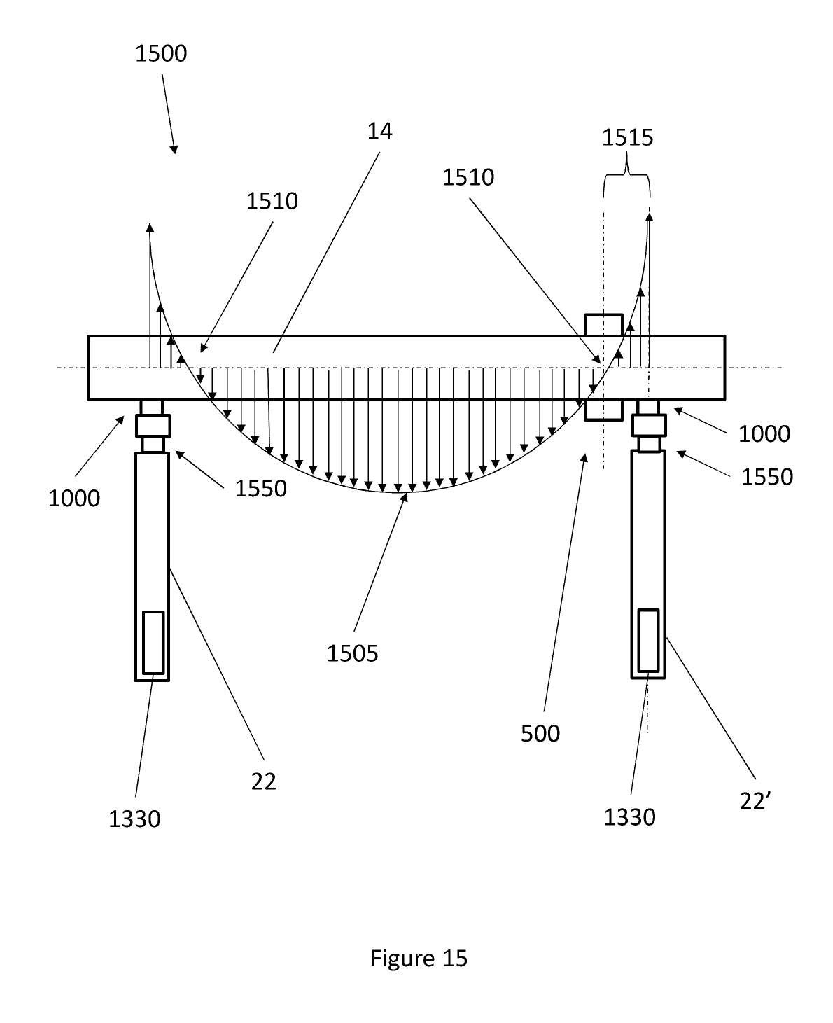

FIG. 15 illustrates a schematic view of an exemplary relative location of an expansion joint 500 on a tube 14 in accordance with embodiments of the present disclosure. As shown in FIG. 15, a tube 14 arranged between adjacent pylons (or pillars) 22, 22′ will have a moment 1505 that varies with the distance from the respective pylons 22, 22′. In accordance with aspects of the disclosure, in embodiments, the expansion joint 500 may be arranged on the tube 14 at (or approximate) a point 1510 of minimum moment (e.g., at a distance 1515 from the pylon 22′). It should be understood that the expansion joint could alternatively be located at (or approximate to) the other identified point of minimum moment 1510. In accordance with aspects of the disclosure, by arranging the expansion joint 500 in such a manner, stability of tube 14 (and the expansion joint 500 thereon) can be improved. Alternatively, in other embodiments, the disclosure contemplates arranging the expansion joint 500 immediately adjacent a pylon, or anywhere along the length of the tube 14.

As also shown in FIG. 15, each pylon 22, in addition to having the damping system 1000, also includes a vertical damper 1550 structured and arranged to damp any relative movement of the tube 14 to the pylon 22 in the vertical direction. In embodiments, the vertical damper 1550 may include, e.g., at least one spring, a compressible material, a hydraulic cylinder, or a pneumatic cylinder.

As further shown in FIG. 15, each pylon 22, 22′ includes an active controller 1330 having at least one processor, and is configured to actively control aspects of the tube stability system (e.g., the damping system 1000, 1550 and/or the tube expansion joints 500). In accordance with aspects of the disclosure, the controllers 1330 may be operable to send and receive control signals, e.g., via satellite, mobile, Wi-Fi, or other suitable communication system, and provide active control based on the received control signals, and to send control signals to respective controllers of other pylons. For example, the controller 1330 of pylon 22 may be operable to send and/or receive control signals to and from controller 1330 of pylon 22′.

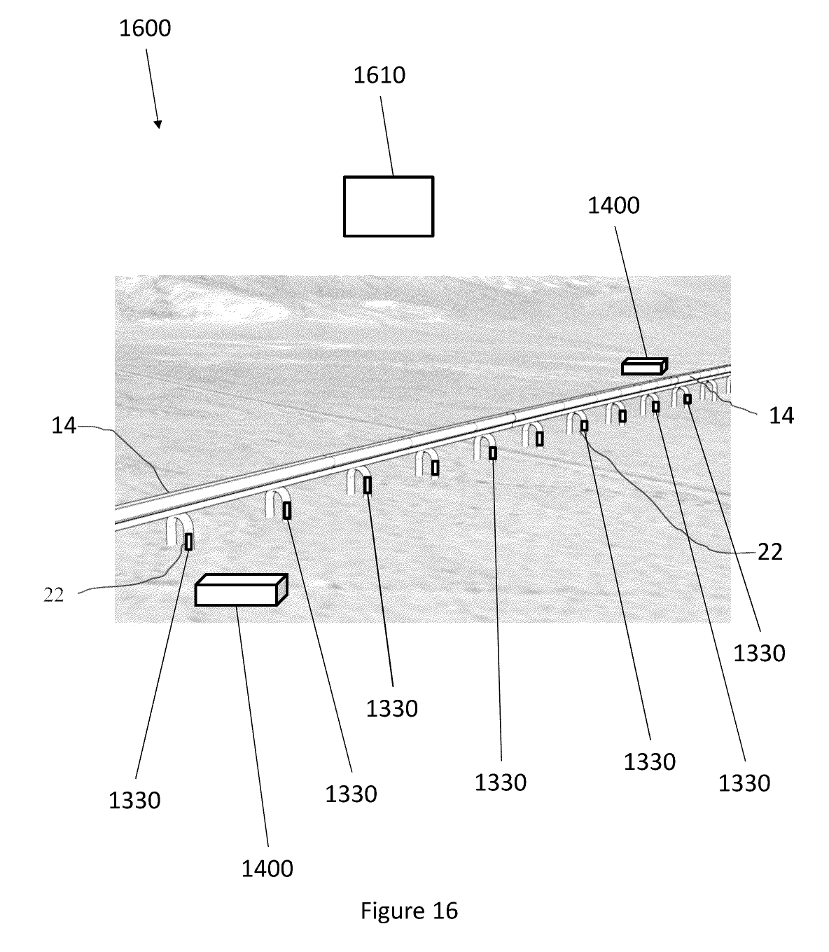

FIG. 16 illustrates a schematic view of an exemplary active tubular structure stability system 1600 in accordance with embodiments of the present disclosure. As shown in FIG. 16, a transportation system includes a pair of tubes 14 supported by a plurality of pylons (or pillars) 22. As shown in FIG. 16, with this exemplary embodiment, each pylon 22 includes an active controller 1330 configured to control the tubular structure stability systems of respective pylons 22. Additionally, as shown in FIG. 16, two mobile command centers 1400 are arranged in different regions along the transportation path. A communication device 1610 (e.g., a satellite) is in communication with at least the mobile command centers 1400.

In accordance with aspects of the disclosure, by arranging the mobile command centers 1400 in regions of high activity (e.g., seismic, thermal, weather), the mobile command centers 1400 are able to receive, e.g., a control command or an alert, via communication device 1610 from at least one central command (not shown), and transmit the control command and/or alert to one or more active controllers 1330 configured to control the respective pylon 22. Additionally, the active controllers 1330 may be configured to retransmit (e.g., forward) a control signal a next respective pylon 22. For example, a damping control signal (indicating parameters for a particular pylon actuation) may be repeated by each respective pylon to the next pylon, such that each commanded pylon acts in a substantially similar manner. In further embodiments, the active controllers 1330 may be configured to determine a downstream control signal for a next respective pylon based on the received control signal. For example, a damping control signal may be modified by each respective pylon to the next pylon, for example, to decrease a relative commanded movement, as a distance of each pylon from an epicenter of activity increases, such that each commanded pylon may act in a different manner.

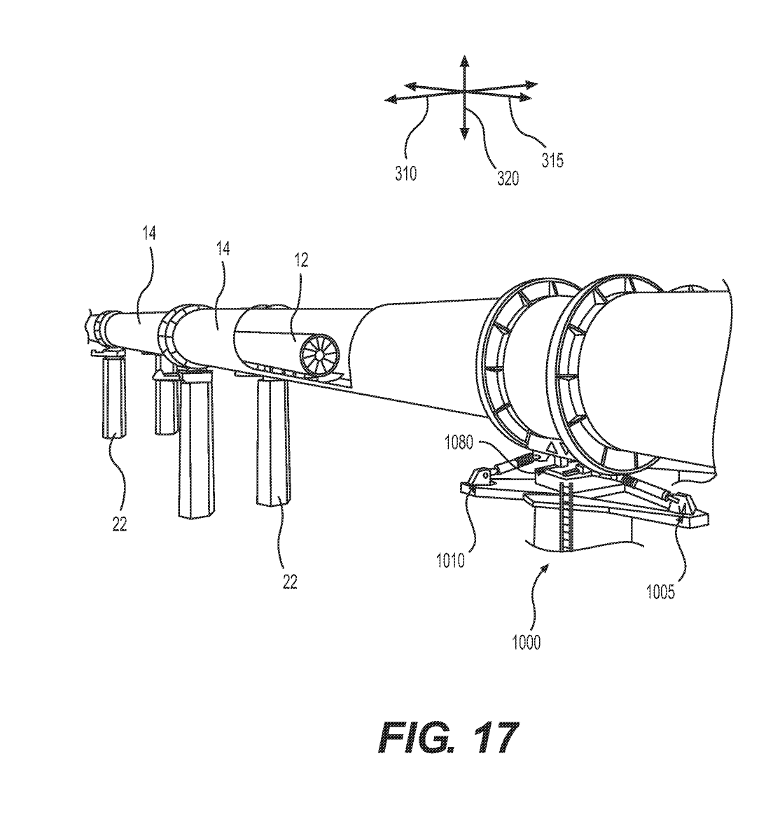

FIG. 17 illustrates a perspective partial cut-away view of a portion of an exemplary low-pressure environment structure with an exemplary damping system 1000 in accordance with embodiments of the present disclosure. FIG. 17 depicts tubes 14 of the transportation system with a partial cut-away view showing an interior of the tube 14 with a capsule 12 therein. As shown in FIG. 17, the tubes 14 may be indirectly connected to the pillars 22 with a damping system 1000, which is supported by the pillars 22. This exemplary dampening system 1000 is structured and arranged to constrain the tubes 14 in a vertical direction (i.e., direction 320) while enabling longitudinal slip for thermal expansion as well as dampened lateral slip with sliding arrangement 1080. As shown in FIG. 17, the damping system 1000 includes a longitudinal damper arrangement 1005 structured and arranged to damp a relative longitudinal (i.e., direction 315) movement, and a lateral damper arrangement 1010 structured and arranged to damp a relative lateral (i.e., direction 310) movement.

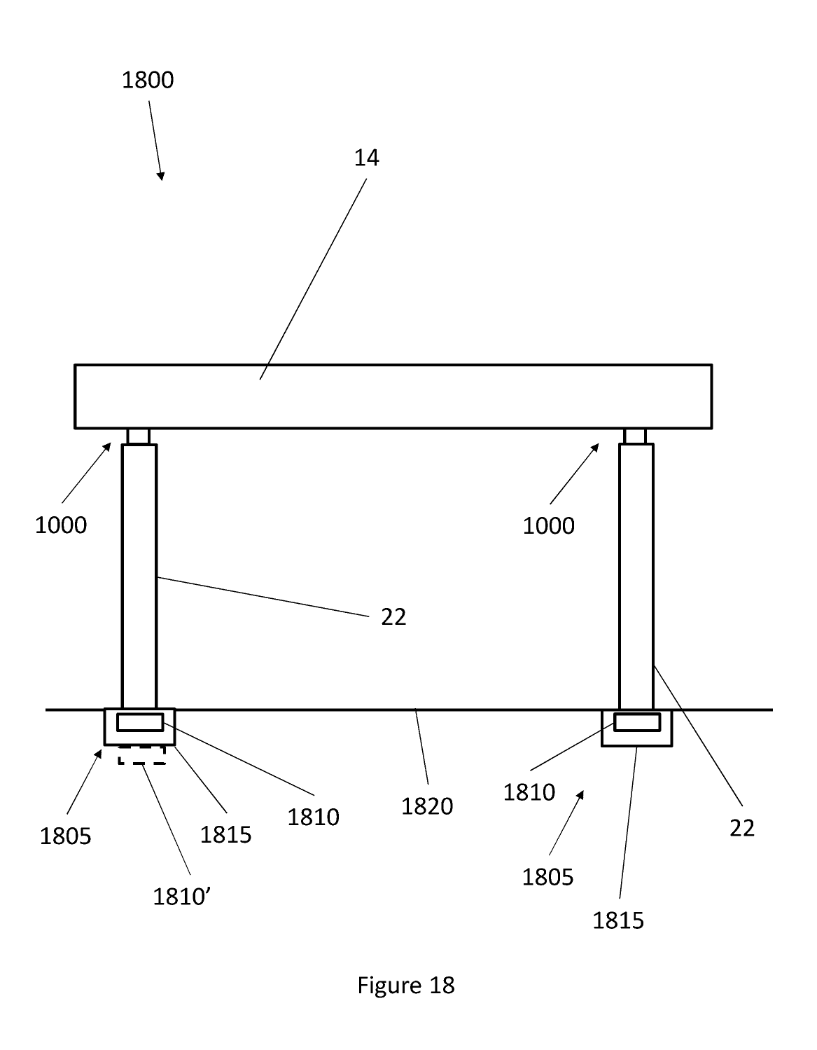

FIG. 18 illustrates a schematic view of an exemplary damping system 1800 in accordance with embodiments of the present disclosure. As shown in FIG. 18, a tube 14 is arranged between adjacent pylons (or pillars) 22, and each pylon 22 includes damping system 1000. In accordance with further aspects of the disclosure, exemplary damping system 1800 also includes a vertical damper system 1805 structured and arranged to damp any relative movement between the pylon 22 and the ground 1820 in the vertical direction. With this exemplary embodiment, a layer of highly viscous material is arranged to support the tube pylons 22. For example, in accordance with aspects of the disclosure, the vertical damper system 1805 comprises a containment structure 1815 holding a pylon viscous liquid support layer 1810, wherein a pylon 22 is supported on the pylon viscous liquid support layer 1810. In embodiments, the layer 1810 may be a thin layer of highly viscous material. In accordance with aspects of the disclosure, in some embodiments, the viscous liquid layer 1810 may be poured under the foundation of the pylon 22.

In contemplated embodiments, the pylon 22 may be indirectly supported on the pylon viscous liquid support layer 1810 via a layer of the cavity 1815. In embodiments, the cavity 1815 holding the liquid 1810 may be air-tight to prevent against damping fluid leaks. In accordance with aspects of the disclosure, the liquid 1810 is operable to support the weight of the tube structure, while diffusing energy that is introduced to the system. In embodiments, the pylon foundation may be directly supported on the pylon viscous liquid support layer 1810′ (as schematically indicated with dashed lines). In other contemplated embodiments, the pylon 22 may be directly supported on the pylon viscous liquid support layer. By implementing aspects of the disclosure, the layer of highly viscous liquid 1810 is operable to absorb and/or diffuse impulsive forces introduced in the pylon 22, thus creating a more stable and secure transportation system.

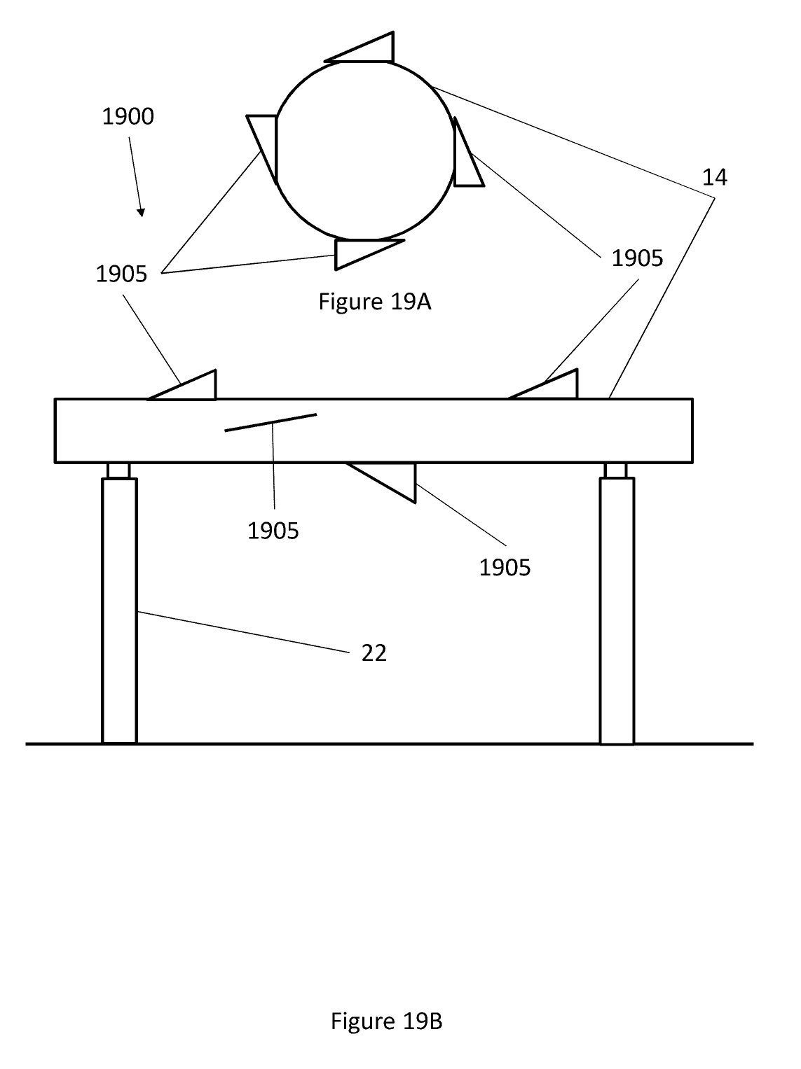

FIGS. 19A-19B illustrate schematic views of an exemplary stabilization arrangement 1900 in accordance with embodiments of the present disclosure. As schematically depicted in FIGS. 19A and 19B, in embodiments a tube 14 supported on pylons 22 may include at least one vortex shedding fin 1905 (or strake) arranged around a circumference of the tube. While not shown, the disclosure also contemplates arranging one or more vortex shedding fins on one or more of the pylons 22. Vortex shedding and acoustic flutter can have devastating effects on infrastructure. In fluid dynamics, vortex shedding is an oscillating flow that takes place when a fluid such as air or water flows past a body at certain velocities, depending on the size and shape of the body. In this flow, vortices are created at the back of the body and detach periodically from either side of the body. The fluid flow past the object creates alternating low-pressure vortices on the downstream side of the object. The object will tend to move toward the low-pressure zone. If the structure is not mounted sufficiently rigidly, for example, and the frequency of vortex shedding matches the resonance frequency of the structure, the structure can begin to resonate, vibrating with harmonic oscillations driven by the energy of the flow. Thus, vortex shedding and acoustic flutter can have significantly damaging impacts on the transportation tube system (e.g., the tube itself, as well as the pylons supporting the tube).

In accordance with aspects of the disclosure, in some embodiments linear and/or spiral fins 1905 are structured and arranged to wrap around transportation tube 14, and are utilized to disrupt air flow so as to reduce vortex shedding.

In embodiments, anti-vortex shedding may also be used to either facilitate or enhance the reduction of vortex shedding. For example, in embodiments, an anti-vortex shedding fin (not shown) could be used to either facilitate or enhance certain aspects of the tube, e.g., enhance structural integrity of tube 14.

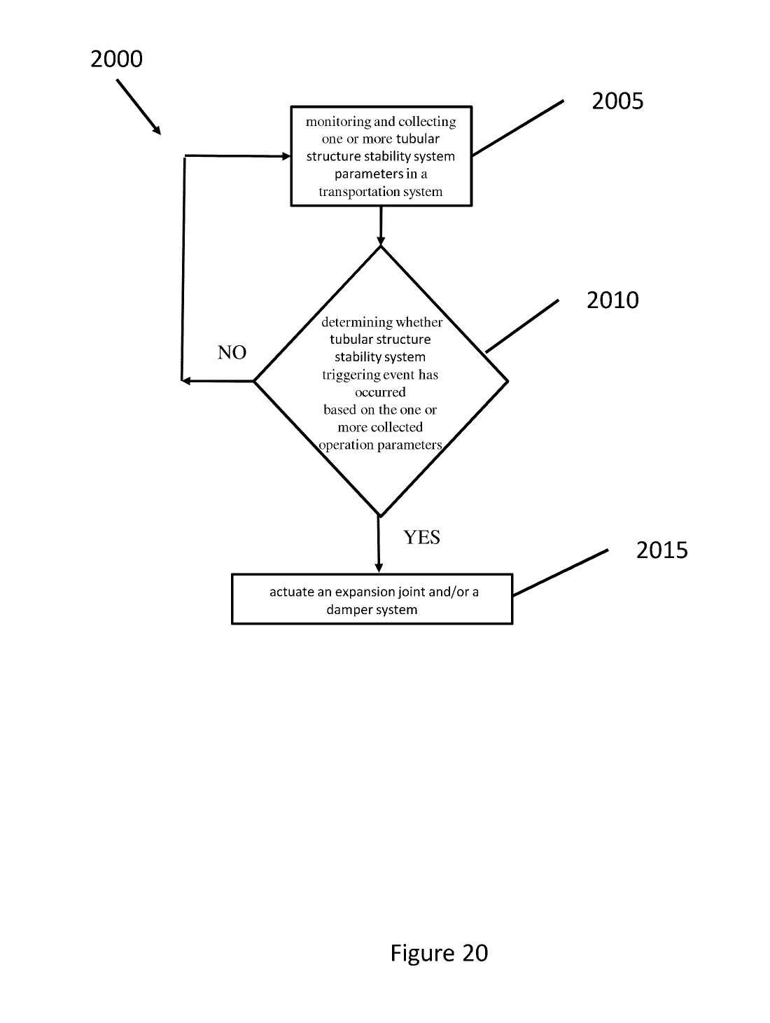

FIG. 20 illustrates an exemplary process 2000 for controlling a tubular structure stability system in accordance with embodiments of the present disclosure. At step 2005, a pylon active controller (e.g., comprising one or more processors) is operable to monitor and/or receive one or more tubular structure stability system parameters of a transportation system. At step 2010, the active controller is operable to determine (e.g., detect) whether a tubular structure stability system triggering event has occurred. For example, the active controller may detect a signal from a central command to actuate a tubular structure stability system control (e.g., actuation of an expansion joint and/or actuation of a damper system, or may receive a triggering signal from a suitable sensor (e.g., a seismic sensor). If, at step 2010, the active controller detects a stability system control triggering event, at step 2015, the active controller is operable to actuate an expansion joint and/or a damper system. If, at step 2010, the active controller does not detect a stability system control triggering event, the process continues at step 2005.

### System Environment

Aspects of embodiments of the present disclosure (e.g., control systems for the tube environment, capsule control systems, tube orientation, tube switching systems) can be implemented by such special purpose hardware-based systems that can perform the specified functions or acts, or combinations of special purpose hardware and computer instructions and/or software, as described above. The control systems may be implemented and executed from either a server, in a client server relationship, or they may run on a user workstation with operative information conveyed to the user workstation. In an embodiment, the software elements include firmware, resident software, microcode, etc.

As will be appreciated by one skilled in the art, aspects of the present disclosure may be embodied as a system, a method or a computer program product. Accordingly, aspects of embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure (e.g., control systems) may take the form of a computer program product embodied in any tangible medium of expression having computer-usable program code embodied in the medium.

Any combination of one or more computer usable or computer readable medium(s) may be utilized. The computer-usable or computer-readable medium may be, for example, but not limited to, an electronic, magnetic, optical, electromagnetic, infrared, or semiconductor system, apparatus, device, or propagation medium. More specific examples (in the form of a non-exhaustive list) of the computer-readable medium would include the following:
an electrical connection having one or more wires,
a portable computer diskette,
a hard disk,
a random access memory (RAM),
a read-only memory (ROM),
an erasable programmable read-only memory (EPROM or Flash memory),
an optical fiber,
a portable compact disc read-only memory (CDROM),
an optical storage device,
a transmission media such as those supporting the Internet or an intranet,
a magnetic storage device
a usb key, and/or
a mobile phone.

In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network. This may include, for example, a local area network (LAN) or a wide area network (WAN), or the connection may be made to an external computer (for example, through the Internet using an Internet Service Provider). Additionally, in embodiments, the present invention may be embodied in a field programmable gate array (FPGA).

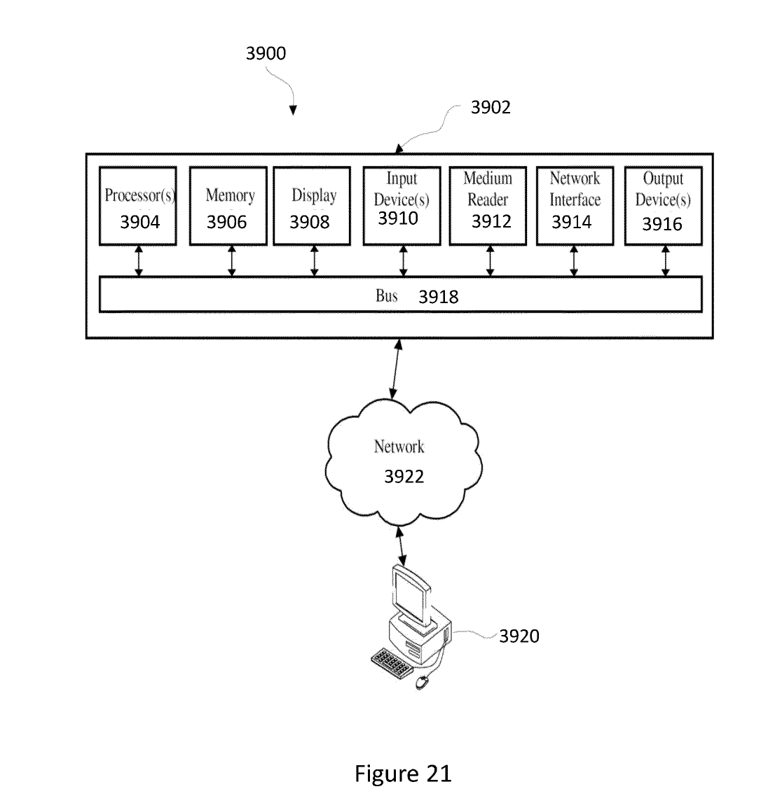

FIG. 21 is an exemplary system for use in accordance with the embodiments described herein. The system 3900 is generally shown and may include a computer system 3902, which is generally indicated. The computer system 3902 may operate as a standalone device or may be connected to other systems or peripheral devices. For example, the computer system 3902 may include, or be included within, any one or more computers, servers, systems, communication networks or cloud environment.

The computer system 3902 may operate in the capacity of a server in a network environment, or in the capacity of a client user computer in the network environment. The computer system 3902, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless telephone, a personal trusted device, a web appliance, or any other machine capable of executing a set of instructions (sequential or otherwise) that specify actions to be taken by that device. Further, while a single computer system 3902 is illustrated, additional embodiments may include any collection of systems or sub-systems that individually or jointly execute instructions or perform functions.

As illustrated in FIG. 21, the computer system 3902 may include at least one processor 3904, such as, for example, a central processing unit, a graphics processing unit, or both. The computer system 3902 may also include a computer memory 3906. The computer memory 3906 may include a static memory, a dynamic memory, or both. The computer memory 3906 may additionally or alternatively include a hard disk, random access memory, a cache, or any combination thereof. Of course, those skilled in the art appreciate that the computer memory 3906 may comprise any combination of known memories or a single storage.

As shown in FIG. 21, the computer system 3902 may include a computer display 3908, such as a liquid crystal display, an organic light emitting diode, a flat panel display, a solid state display, a cathode ray tube, a plasma display, or any other known display. The computer system 102 may include at least one computer input device 3910, such as a keyboard, a remote control device having a wireless keypad, a microphone coupled to a speech recognition engine, a camera such as a video camera or still camera, a cursor control device, or any combination thereof. Those skilled in the art appreciate that various embodiments of the computer system 3902 may include multiple input devices 3910. Moreover, those skilled in the art further appreciate that the above-listed, exemplary input devices 3910 are not meant to be exhaustive and that the computer system 3902 may include any additional, or alternative, input devices 3910.

The computer system 3902 may also include a medium reader 3912 and a network interface 3914. Furthermore, the computer system 3902 may include any additional devices, components, parts, peripherals, hardware, software or any combination thereof which are commonly known and understood as being included with or within a computer system, such as, but not limited to, an output device 3916. The output device 3916 may be, but is not limited to, a speaker, an audio out, a video out, a remote control output, or any combination thereof.

Furthermore, aspects of the disclosure may take the form of a computer program product accessible from a computer-usable or computer-readable medium providing program code for use by or in connection with a computer or any instruction execution system. The software and/or computer program product can be implemented in the environment of FIG. 21. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable storage medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disc-read/write (CD-R/W) and DVD.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

Accordingly, the present disclosure provides various systems, structures, methods, and apparatuses. Although the disclosure has been described with reference to several exemplary embodiments, it is understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular materials and embodiments, embodiments of the invention are not intended to be limited to the particulars disclosed; rather the invention extends to all functionally equivalent structures, methods, and uses such as are within the scope of the appended claims.

While the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk, tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. For example, while many of the structures discussed herein may be used in the context of a low-pressure environment for a high-speed transportation system, the enclosed environments may also be utilized in different contexts (e.g., other high-speed transportation systems, or vacuum facilities for clean rooms). Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Accordingly, the present disclosure provides various systems, structures, methods, and apparatuses. Although the disclosure has been described with reference to several exemplary embodiments, it is understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular materials and embodiments, embodiments of the invention are not intended to be limited to the particulars disclosed; rather the invention extends to all functionally equivalent structures, methods, and uses such as are within the scope of the appended claims.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

While the invention has been described with reference to specific embodiments, those skilled in the art will understand that various changes may be made and equivalents may be substituted for elements thereof without departing from the true spirit and scope of the invention. While exemplary embodiments are described above, it is not intended that these embodiments describe all possible forms of the invention. Rather, the words used in the specification are words of description rather than limitation, and it is understood that various changes may be made without departing from the spirit and scope of the disclosure. In addition, modifications may be made without departing from the essential teachings of the invention. Furthermore, the features of various implementing embodiments may be combined to form further embodiments of the invention.

What is claimed is:

1. A tubular structure stability system, comprising:
at least one tube having tube sections;
at least one pillar supporting the tube;
a tube movement structure configured to enable relative movement of the tube sections and/or of a tube section relative to the at least one pillar.

2. The tubular structure stability system of claim 1, wherein the tube movement structure comprises at least one expansion joint connecting the tube sections.

3. The tubular structure stability system of claim 2, wherein the at least one expansion joint comprises a passive expansion joint.

4. The tubular structure stability system of claim 2, wherein the at least one expansion joint comprises an actively-controllable expansion joint configured to be selectively actuatable.

5. The tubular structure stability system of claim 2, wherein the at least one expansion joint comprises:
a first housing attached to a first tube section,
a second housing attached to a second tube section,
wherein the first housing is slidably engageable with the second housing.

6. The tubular structure stability system of claim 5, wherein the at least one expansion joint further comprises:
a plurality of connectors arranged to connect the first housing and the second housing, and
respective actuators structured and configured to adjust an effective length of the plurality of connectors so as to selectively control spacing between the first housing and the second housing.

7. The tubular structure stability system of claim 6, wherein the respective actuators comprise linear actuators.

8. The tubular structure stability system of claim 6, wherein the respective actuators comprise rotary actuators.

9. The tubular structure stability system of claim 2, wherein the at least one expansion joint comprises a gap bridging system operable to actuate at least one gap bridger into a gap between adjacent tube sections.

10. The tubular structure stability system of claim 9, wherein the gap bridging system is a passive gap bridging system.

11. The tubular structure stability system of claim 9, wherein the gap bridging system is an actively-controllable gap bridging system.

12. The tubular structure stability system of claim 9, wherein the gap bridging system is vertically actuatable.

13. The tubular structure stability system of claim 9, wherein the gap bridging system is horizontally actuatable.

14. The tubular structure stability system of claim 1, wherein the tube movement structure comprises:
a sliding arrangement configured to enable relative movement between a respective tube and a respective pillar; and
a damping arrangement configured to damp movement between the respective tube and the respective pillar.

15. The tubular structure stability system of claim 14, wherein the sliding arrangement comprises:
a plurality of longitudinal rails fixed positionally relative to the respective tube;
a plurality of lateral rails fixed positionally relative to the respective pillar; and
a plurality of sliders, each configured to be slidable along one of the plurality of longitudinal rails and one of the plurality of lateral rails.

16. The tubular structure stability system of claim 15, wherein the plurality of longitudinal rails are arranged orthogonally relative to the plurality of lateral rails.

17. The tubular structure stability system of claim 14, wherein the damping arrangement comprises:
a longitudinal damping arrangement structured and arranged to damp longitudinal movement of the tube relative to the at least one pillar; and
a lateral damping arrangement structured and arranged to damp lateral movement of the tube relative to the at least one pillar.

18. The tubular structure stability system of claim 14, wherein the damping arrangement comprises a damper having a first end attached in mechanical connection with the pillar and a second end in mechanical connection to the tube.

19. The tubular structure stability system of claim 18, wherein the damper additionally comprises an actuator selectively controllable to alter an effective length of the damper.

20. The tubular structure stability system of claim 14, wherein the damper arrangement comprises at least one actively-controllable damper.

21. The tubular structure stability system of claim 14, wherein the damping arrangement comprises at least one vertical damper.

22. The tubular structure stability system of claim 1, further comprising a mobile command center configured to monitor and/or control the tube movement structure.

23. The tubular structure stability system of claim 1, further comprising a pillar movement structure configured to enable movement of the at least one pillar relative to ground on which the at least one pillar is supported.

24. The tubular structure stability system of claim 1, further comprising at least one vortex shedding fin arranged on the at least one tube and/the at least one pillar.

25. The tubular structure stability system of claim 1, wherein the at least one tube is configured as a low-pressure environment.

26. The tubular structure stability system of claim 2, wherein the at least one expansion joint is structured and configured to maintain a low-pressure environment within the connected tube sections.

27. The tubular structure stability system of claim 1, further comprising a high-speed transportation system, comprising:
at least one track along a transportation path within the at least one tube;
a plurality of capsules configured for travel through the at least one tube between stations;
a propulsion system adapted to propel the at least one capsule through the tube; and
a levitation system adapted to levitate the capsule within the tube.

28. A method of actively controlling the tubular structure stability system comprising at least one tube having tube sections; at least one pillar supporting the tube; a tube movement structure configured to enable relative movement of the tube sections and/or of a tube section relative to the at least one pillar, the method comprising:
receiving a command for actuation of an expansion joint and/or a damper; and
executing the command to move at least one of the expansion joint and the damper.
